(19) United States
(12) Patent Application Publication
(10) Pub. No.: US 2015/0380785 A1
(43) Pub. Date: Dec. 31, 2015

(54) TEMPERATURE REGULATION DEVICE

(71) Applicant: DENSO CORPORATION, Kariya-city, Aichi (JP)

(72) Inventors: Masayuki TAKEUCHI, Nukata-gun (JP); Takashi YAMANAKA, Kariya-city (JP)

(73) Assignee: DENSO CORPORATION, Kariya-city, Aichi-pref. (JP)

(21) Appl. No.: 14/766,686

(22) PCT Filed: Jan. 15, 2014
(86) PCT No.: PCT/JP2014/000155

§ 371 Date: Aug. 7, 2015

(30) Foreign Application Priority Data
Feb. 11, 2013 (JP) 2013-023946

(51) Int. Cl. H01M 10/663; H01M 10/6563; H01M 10/625; B60H 1/00; H01M 10/615

(52) U.S. Cl. CPC H01M 10/663; B60H 1/00278; H01M 10/615; H01M 10/625; H01M 10/6563

(57) ABSTRACT

In a temperature regulation device, when a control device determines that warming-up operation of an assembled battery is necessary, and when a humidity of an air detected by a temperature/humidity sensor is equal to or lower than a predetermined humidity, a conditioned air that has been drawn from a vehicle interior and heated is blown to the assembled battery through a battery guide passage. When the humidity of the detected air exceeds the predetermined humidity, an air that has been drawn from a vehicle exterior and heated by a vehicle air conditioning apparatus is blown to the assembled battery through the battery guide passage.

### CROSS REFERENCE TO RELATED APPLICATION

This application is based on and incorporates herein by reference Japanese Patent Application No. 2013-023946 filed on Feb. 11, 2013.

### TECHNICAL FIELD

The present disclosure relates to a temperature regulating device that regulates a temperature by blowing an air to an electric device of a vehicle.

### BACKGROUND ART

Conventionally, temperature regulation objects, which require temperature regulation in the vehicle, are a secondary battery that stores an electric power for traveling an electric vehicle or a hybrid vehicle, and various electronic components that produce heat during use, for example. Each of those temperature regulation objects has an appropriate temperature range suitable to exert its function, and requires the temperature regulating device that can regulate the temperature to the appropriate temperature range as occasion demands.

As the above temperature regulating device, a device disclosed in Patent Document 1 has been known. The temperature regulating device of Patent Document 1 introduces a temperature regulated air blown from an air conditioning apparatus for conditioning a vehicle interior air into a battery housing chamber to cool or heat the battery.

### PRIOR ART DOCUMENT

### Patent Document

Patent Document 1: Japanese Patent No. 3125198

### SUMMARY OF THE INVENTION

In the device of Patent Document 1, a hot air during heating operation can be blown to the battery to perform vehicle interior air conditioning and battery warm-up. Normally, in the case of the heating operation, for the purpose of securing heating efficiency, an inside air mode for circulating a vehicle interior air is frequently employed. However, the vehicle interior air is higher in absolute humidity than an outside air due to breath and sweating of an occupant. For that reason, when the inside air mode and the heating operation are executed together to implement the battery warm-up, the vehicle interior air which is higher in the absolute humidity is heated, and blown to the battery with the results that dew condensation is likely to occur on a battery surface.

The present disclosure has been made in view of the above-described points, and it is an objective of the present disclosure is to provide a temperature regulating device that suppresses dew condensation on the electric device and secures a heating efficiency when a warming-up operation for the electric device is performed with the use of a conditioned air generated by a vehicle air conditioning apparatus.

According to an aspect of the present disclosure, a temperature regulating device includes a vehicle air conditioning apparatus that is mounted in a vehicle and blows a conditioned air to a vehicle interior, a communication passage through which the vehicle air conditioning apparatus communicates with an electric device mounted in the vehicle, a conditioned air being conveyed from the vehicle air conditioning apparatus to the electric device through the communication passage, a temperature detection device that detects a temperature of the electric device, a humidity detection device that detects a humidity of an air in the vehicle interior or an air drawn into the vehicle air conditioning apparatus from the vehicle interior, and a control device that controls an operation of the vehicle air conditioning apparatus according to temperature information detected by the temperature detection device and humidity information detected by the humidity detection device. The control device determines whether a warming-up operation for heating the electric device is necessary on the basis of the temperature of the electric device which is detected by the temperature detection device. When the control device determines that the warming-up operation is necessary, and when the humidity of the air detected by the humidity detection device is equal to or lower than a predetermined humidity, the vehicle air conditioning apparatus blows the air, which is drawn from the vehicle interior and heated, to the electric device through the communication passage. When the control device determines that the warming-up operation is necessary, and when the humidity of the air detected by the humidity detection device exceeds the predetermined humidity, the vehicle air conditioning apparatus blows air, which is drawn from a vehicle exterior and heated, to the electric device through the communication passage.

According to the above configuration, when the humidity of the vehicle interior air is high in the warming-up operation, a vehicle exterior air which can be assumed to be lower in the humidity than the vehicle interior air is blown to the electric device. Further, when the humidity of the vehicle interior air is not high, a vehicle interior air which can be assumed to be higher in the humidity than the vehicle exterior air is blown to the electric device. With the above configuration, the warming-up operation can be implemented, which can suppress the generation of the dew condensation in the electric device. The generation of the dew condensation in the electric device is caused by blowing the vehicle interior air higher in absolute humidity than the outside air due to breath and sweating of the occupant. Further, the warming-up operation can be implemented, which can suppress a reduction in the heating efficiency caused by heating and blowing the vehicle exterior air. This makes it possible to provide the temperature regulating device that suppresses the dew condensation on the electric device and secures the heating efficiency in implementing the warming-up operation on the electric device with the use of the conditioned air caused by the vehicle air conditioning apparatus.

According to another aspect of the present disclosure, a temperature regulating device includes a vehicle air conditioning apparatus that is mounted in a vehicle and blows a conditioned air to a vehicle interior, the vehicle air conditioning apparatus being a vehicle air conditioning apparatus of an inside-outside-air two-layered type and including an outside air introduction passage in which the air drawn from the vehicle exterior flows, and an inside air introduction passage in which the air drawn from the vehicle interior flows, the introduction passages being independent from each other, a communication passage through which the vehicle air conditioning apparatus communicates with an electric device mounted in the vehicle, a conditioned air being conveyed from the vehicle air conditioning apparatus to the electric device through the communication passage, a temperature detection device that detects a temperature of the electric device, a control device that controls an operation of the vehicle air conditioning apparatus according to temperature information detected by the temperature detection device. When the control device determines that a warming-up operation for heating the electric device is necessary on the basis of the temperature of the electric device which is detected by the temperature detection device, the control device performs heating of air flowing from the vehicle exterior through the outside air introduction passage and performs blowing of the heated air to the electric device through the communication passage.

According to the above configuration, in the warming-up operation of the electric device, the outside air that can be assumed to be lower in humidity than the inside air is blown to the electric device. As a result, the generation of the dew condensation in the electric device can be suppressed. The generation of the dew condensation in the electric device is caused by blowing the inside air higher in humidity than the outside air due to the breath and sweating of the occupant. This makes it possible to suppress the dew condensation of the electric device and secure the heating efficiency in implementing the warming-up operation on the electric device with the use of the conditioned air generated by the vehicle air conditioning apparatus.

### BRIEF DESCRIPTION OF THE DRAWINGS

FIG. 1 is a schematic diagram illustrating a temperature regulating device according to a first embodiment of the present disclosure.

FIG. 2 is a block diagram illustrating a control configuration of a control device in the temperature regulating device according to the first embodiment.

FIG. 3 is a flowchart illustrating a control process involved in an in-vehicle heating operation and a battery warming-up operation in the temperature regulating device according to the first embodiment.

FIG. 4 is a flowchart illustrating a control process involved in the battery warming-up operation when there is no request for heating, in the temperature regulating device according to the first embodiment.

FIG. 5 is a schematic diagram illustrating the temperature regulating device at the time of heating and warming up a battery by an inside air according to the first embodiment.

FIG. 6 is a schematic diagram illustrating the temperature regulating device at the time of heating and warming up the battery by an outside air according to the first embodiment.

FIG. 7 is a schematic diagram illustrating the temperature regulating device at the time of warming up the battery by the inside air according to the first embodiment.

FIG. 8 is a schematic diagram illustrating the temperature regulating device at the time of warming up the battery by the outside air according to the first embodiment.

FIG. 9 is a schematic diagram illustrating a temperature regulating device according to a second embodiment of the present disclosure.

FIG. 10 is a block diagram illustrating a control configuration of a control device in the temperature regulating device according to the second embodiment.

FIG. 11 is a flowchart illustrating a control process involved in an in-vehicle heating operation and a battery warming-up operation in the temperature regulating device according to the second embodiment.

FIG. 12 is a flowchart illustrating a control process involved in the battery warming-up operation when there is no request for heating, in the temperature regulating device according to the second embodiment.

FIG. 13 is a schematic diagram illustrating the temperature regulating device at the time of heating and warming up a battery by an inside air according to the second embodiment.

FIG. 14 is a schematic diagram illustrating the temperature regulating device at the time of heating and warming up the battery by an outside air according to the second embodiment.

FIG. 15 is a schematic diagram illustrating the temperature regulating device at the time of warming up the battery by the inside air according to the second embodiment.

FIG. 16 is a schematic diagram illustrating the temperature regulating device at the time of warming up the battery by the outside air according to the second embodiment.

FIG. 17 is a schematic diagram illustrating a temperature regulating device according to a third embodiment of the present disclosure.

FIG. 18 is a block diagram illustrating a control configuration of a control device in the temperature regulating device according to the third embodiment.

FIG. 19 is a flowchart illustrating a control process involved in an in-vehicle heating operation and a battery warming-up operation in the temperature regulating device according to the third embodiment.

FIG. 20 is a flowchart illustrating a control process involved in the battery warming-up operation when there is no request for heating, in the temperature regulating device according to the third embodiment.

FIG. 21 is a schematic diagram illustrating the temperature regulating device in heating operation according to the third embodiment.

FIG. 22 is a schematic diagram illustrating the temperature regulating device at the time of heating and battery heating (outside air) operation according to the third embodiment.

### EMBODIMENTS FOR EXPLOITATION OF THE INVENTION

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

A temperature regulating device according to the present disclosure is applied to, for example, automobiles having an internal combustion engine as a traveling drive source, hybrid vehicles with the combination of the internal combustion engine and a motor driven by an electric power charged in a secondary battery as the traveling drive source, and electric vehicles having a motor as the traveling drive source. Temperature regulation objects to be regulated in temperature are a battery mounted in the vehicle and an electric device such as an electronic component.

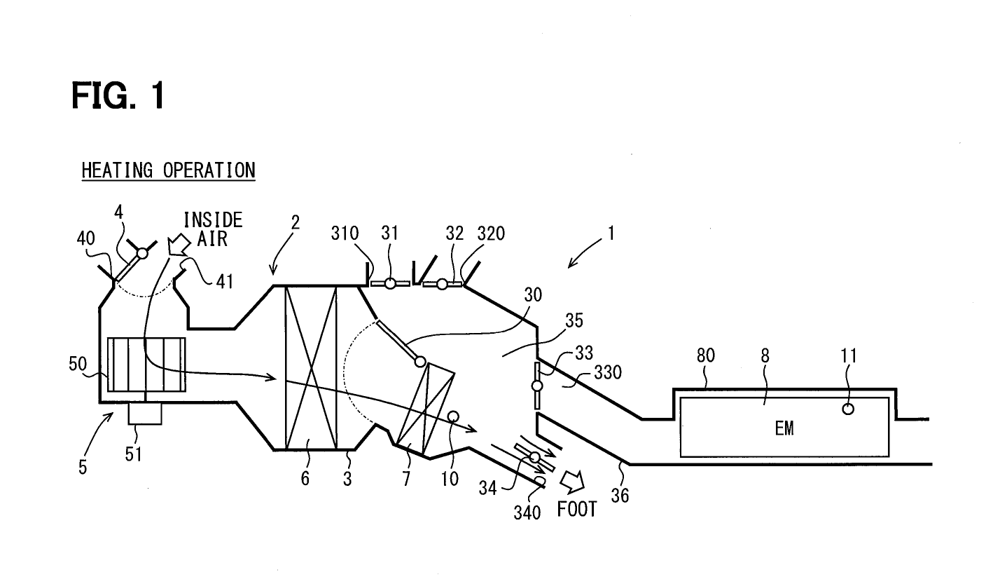

A first embodiment which is one of embodiments in the present disclosure will be described with reference to FIGS. 1 to 8. FIG. 1 illustrating a configuration of a temperature regulating device 1 illustrates an operating state of the temperature regulating device 1 during heating operation for heating a vehicle interior. In the first embodiment, an embodiment in which an assembled battery as an example of an object to be regulated in temperature is regulated in temperature will be described.

A secondary battery configuring an assembled battery 8 is chargeable and dischargeable, and intended to supply an electric power to a vehicle traveling motor. The electric power is stored in respective electric cells configuring the assembled battery 8. The respective electric cells are, for example, nickel-hydrogen secondary batteries, lithium ion secondary batteries, or organic radical batteries. The assembled battery 8 includes multiple electric cells conductively connected to each other, and is disposed, for example, below seats of the automobile, in a space between a rear seat and a trunk room, or in a space between a driver's seat and a front passenger seat in a state where the assembled battery 8 is housed in a case.

The temperature regulating device 1 includes the assembled battery 8 (EM), a vehicle air conditioning apparatus 2 that can blow an air regulated in temperature (also called “temperature regulated air”) to the assembled battery 8, and a control device 100 (air conditioning ECU) that controls the operation of the respective components to switch an air passage in which the temperature regulated air flows to another according to an operation mode. The vehicle air conditioning apparatus 2 is installed on an instrument panel back of the vehicle, and can implement vehicle interior air conditioning, and supply the temperature regulated air to the assembled battery 8 to cool and warm up the assembled battery 8.

The assembled battery 8 is an example of the electric device that is a temperature regulation object mounted in the vehicle and regulated in temperature. The assembled battery 8 is housed in an assembled battery case 80, and includes a battery passage in which an air flows in contact with outer surfaces or electrode terminals of the respective electric cells. The temperature regulated air flows into the battery passage to enable the assembled battery 8 to be regulated in temperature.

The assembled battery 8 is controlled by electronic components (not shown) used for charging, discharging, and temperature regulation of the multiple electric cells, and the respective electric cells are regulated in temperature by the air flowing around the electric cells. The electronic components include an electronic component for controlling a relay and an inverter of a charger, a battery monitoring device, a battery protection circuit, and various control devices. Each of the electric cells has, for example, a flat rectangular parallelepiped outer case, and the electrode terminal protrudes from the outer case. The electrode terminal includes a positive terminal and a negative terminal, which protrude outward from an end surface having a narrow area parallel in a thickness direction, and are arranged at predetermined intervals in the respective electric cells. All of the electric cells in the assembled battery 8 are conductively connected in series from the negative terminal of the electric cell located on one end side in a stacking direction thereof to the positive terminal of the electric cell located on the other end side in the stacking direction by bus bars connected between the electrode terminals of the adjacent electric cells.

Subsequently, a configuration of the vehicle air conditioning apparatus 2 will be described. An evaporator 6 and a condenser 7 included in the vehicle air conditioning apparatus 2 are devices configuring a heat pump cycle. The heat pump cycle is a refrigerant circuit configured by annularly connecting at least a compressor 9, the condenser 7, a decompressor (not shown), an outdoor heat exchanger (not shown), the evaporator 6, and an electromagnetic valve (not shown) as refrigerant circuit switching means.

The heat pump cycle switchably configures a refrigerant circuit of cooling operation for cooling a blast air to provide a cold air by the evaporator 6, and a refrigerant circuit of heating operation for heating the blast air to provide a hot air by the condenser 7. Further, the heat pump cycle may be configured by a cycle capable of forming a refrigerant circuit of dehumidifying and heating operation for cooling the blast air by the evaporator 6, and further heating the blast air by the condenser 7.

The compressor 9 is configured as an electric compressor disposed in a hood of the vehicle which is outside the vehicle, and draws, compresses, and discharges refrigerant in the heat pump cycle, and drives a fixed capacity compression mechanism having a discharge capacity fixed by an electric motor. The fixed capacity compression mechanism can be configured by various compression mechanisms such as a scroll compression mechanism or a vane compression mechanism. The electric motor is an AC motor having a rotating speed controlled by, for example, an AC voltage output from the inverter. The inverter outputs the AC voltage of a frequency corresponding to a control signal output from the control device 100. A refrigerant discharge capacity of the compressor 9 is changed under the frequency or rotating speed control.

The condenser 7 is disposed downstream of the evaporator 6 in an air conditioning case 3 forming an air passage of the blast air which is blown into the vehicle interior. The condenser 7 is a heating heat exchanger that heats a passing air by an action of allowing the refrigerant compressed by the compressor 9 to radiate a heat to the air passing in the heat exchanging unit during the vehicle interior heating operation or the battery warming-up operation.

The vehicle air conditioning apparatus 2 includes a temperature/humidity sensor 10 for detecting the temperature and humidity of the air that has passed through the heat exchanging unit of the condenser 7. The temperature/humidity sensor 10 functions as a humidity detection device for detecting the humidity of the air taken from the vehicle interior, or the humidity of the air blown to the assembled battery 8, and also functions as a temperature detection device for detecting the temperature of the air. The temperature/humidity sensor 10 is installed downstream of the condenser 7 in an air flow, or installed in an outlet of the heat exchanging unit of the condenser 7 (for example, installed in an outlet of a fin configuring the heat exchanger).

The vehicle air conditioning apparatus 2 includes a humidity sensor 12 which is a humidity detection device for detecting the humidity of the air in the vehicle interior (also called “inside air”). In an outside air mode in which a vehicle exterior air (also called “outside air”) is drawn into the vehicle air conditioning apparatus 2, because the humidity of the vehicle interior air cannot be detected by the temperature/humidity sensor 10, the humidity of the vehicle interior air is detected by the humidity sensor 12. The humidity sensor 12 is a humidity detection device for detecting the humidity of the vehicle interior air, and installed at a predetermined place in the vehicle interior. For example, a humidity sensor provided for predicting the window cloudy of a front window can be used for the humidity sensor 12.

The evaporator 6 is a cooling heat exchanger that is disposed upstream of the condenser 7 in the air conditioning case 3, and performs heat exchange between a refrigerant flowing in the air conditioning case 3 and the blast air to cool the blast air. The evaporator 6 is a cooling heat exchanger that cools a passing air by an action of allowing the refrigerant decompressed by the decompressor to absorb heat from an air passing in the heat exchanging unit during the vehicle interior cooling operation or the battery cooling operation.

The outdoor heat exchanger is disposed in the hood, and performs heat exchange between a refrigerant flowing in the outdoor heat exchanger and the vehicle exterior air (outside air) blown from an outdoor fan (not shown). The outdoor fan is an electric blower having a rotating speed (blowing capacity) controlled by a control voltage output from the control device 100.

An air conditioning unit included in the vehicle air conditioning apparatus 2 houses an indoor blower 5, the evaporator 6, the condenser 7, and an air mix door 30 within the air conditioning case 3 forming an outer shell of the air conditioning unit. The air conditioning case 3 is molded with resin (for example, polypropylene) having certain elasticity and further excellent in strength, and an air passage of the blast air that is blown into the vehicle interior is formed inside of the air conditioning case 3. An inside/outside air switching device that switchably introduces the inside air or the outside air into the case is disposed on the most upstream side of an air flow in the air conditioning case 3.

The inside/outside air switching device continuously regulates opening areas of an inside air inlet port 41 and an outside air inlet port 40 by the aid of an inside/outside air switching door 4 to continuously change a flow proportion of a flow rate of the inside air to a flow rate of the outside air. The inside air inlet port 41 is configured to introduce the inside air into the air conditioning case 3, and the outside air inlet port 40 is configured to introduce the outside air into the air conditioning case 3. The inside/outside air switching door 4 is driven by an electric actuator for the inside/outside air switching door. The operation of the electric actuator is controlled according to a control signal output from the control device 100.

The indoor blower 5 is disposed downstream of the inside/outside air switching device in the air flow. The indoor blower 5 blows the air drawn through the inside/outside air switching device toward the vehicle interior. The indoor blower 5 which is blowing means is an electric blower for driving a centrifugal multi-blade fan 50 by the aid of an electric motor 51, and controlled in rotating speed (air flow rate) by the control voltage output from the control device 100.

The evaporator 6 and the condenser 7 are arranged downstream of the indoor blower 5 in the air flow in the order of the evaporator 6 and the condenser 7 along the flow of the blast air. The air mix door 30 is disposed within the air conditioning case 3. The air mix door 30 regulates a flow proportion of the flow rate passing through the condenser 7 to the flow rate not passing through the condenser 7 in the blast air that has passed through the evaporator 6. The air mix door 30 is driven by an electric actuator for driving the air mix door. The operation of the electric actuator is controlled according to a control signal output from the control device 100.

In the vehicle air conditioning apparatus 2, in the vehicle interior heating operation, the battery warming-up operation, and the dehumidifying and heating operation, as indicated by a solid line in FIG. 1, the air mix door 30 is displaced to a heating position where all flow of the blast air that has passed through the evaporator 6 flows into the condenser 7. Therefore, the blast air that has passed through the evaporator 6 arrives at an air mix unit 35 after passing through the condenser 7. The air mix unit 35 is formed on an upstream side of multiple blowout passages. In the vehicle interior cooling operation and the battery cooling operation, the air mix door 30 is displaced to a cooling position where all flow of the blast air that has passed through the evaporator 6 bypasses the condenser 7. Therefore, the blast air that has passed through the evaporator 6 arrives at the air mix unit 35 without passing through the heat exchanging unit of the condenser 7.

The multiple blowout passages are disposed on the downstream most portion of the air flow in the air conditioning case 3. The multiple blowout passages are configured to blow the blast air that has passed through the condenser 7 or the blast air that has bypassed the condenser 7 into the vehicle interior which is a space to be air-conditioned, or toward the assembled battery 8. Those blowout passages include a defroster passage 310 for blowing the conditioned air toward a vehicle front window glass inner surface, a face passage 320 for blowing the conditioned air toward an upper body of an occupant, a foot passage 340 for blowing the conditioned air toward feet of the occupant, and a battery guide passage 330. Those respective passages are formed by ducts connected to respective opening portions formed in the air conditioning case 3. The defroster passage 310 communicates with a defroster air outlet opened in the vehicle interior. The face passage 320 communicates with face air outlets such as a center face air outlet and a side face air outlet which are opened in the vehicle interior. The foot passage 340 communicates with a foot air outlet opened in the vehicle interior.

A defroster door 31 is disposed on an upstream side of the air flow in the defroster passage 310. The defroster door 31 fully opens or closes the defroster passage 310, and regulates an opening area of the defroster passage 310. A face door 32 is disposed on an upstream side of the air flow in the face passage 320. The face door 32 fully opens or closes the face passage 320, and regulates an opening area of the face passage 320. A foot door 34 is disposed on an upstream side of the air flow in the foot passage 340. The foot door 34 fully opens or closes the foot passage 340, and regulates an opening area of the foot passage 340.

The face door 32, the defroster door 31, and the foot door 34 configure air outlet mode switching means for switching a vent mode, and are coupled with an electric actuator for driving a vent mode door through a link mechanism, and rotate in conjunction with the electric actuator. The operation of the electric actuator is controlled according to the control signal output from the control device 100.

The vent mode that operates according to automatic operation or manual operation includes a face mode, a bi-level mode, a foot mode, and a foot defroster mode. The face mode is a mode for blowing the air toward the upper body of the occupant in the vehicle interior from the center face air outlet. The bi-level mode is a mode for opening both of the center face air outlet and the foot air outlet to blow the air toward the upper body and the feet of the occupant in the vehicle interior. The foot mode is a mode for fully opening the foot air outlet and opening the defroster air outlet by only a small opening degree to blow the air mainly from the foot air outlet. The foot defroster mode is a mode for opening the foot air outlet and the defroster air outlet with the comparable degree to blow the air from both of the foot air outlet and the defroster air outlet. Further, the foot defroster mode can be changed to a defroster mode for fully opening the defroster air outlet to blow the air toward the front window glass inner surface from the defroster air outlet by allowing the occupant to manually operate a vent mode changeover switch disposed on a control panel.

The battery guide passage 330 is a passage formed by a guide duct 36 that couples the air conditioning case 3 with the assembled battery case 80. Therefore, the battery guide passage 330 is an example of a communication passage that communicates the vehicle air conditioning apparatus 2 with an electric device in order to blow the conditioned air from the vehicle air conditioning apparatus 2 to the electric device mounted in the vehicle. The battery guide passage 330 is a passage extending from the opening portion defined in the air conditioning case 3 between the face passage 320 and the foot passage 340 to a rear of the vehicle. Therefore, the battery guide passage 330 communicates with the air mix unit 35, and is located at a position below the face passage 320 and above the foot passage 340.

The battery guide passage 330 is configured to communicate with the vehicle exterior or the vehicle interior through the passage in the assembled battery case 80. Therefore, after the blast air that flows through the battery guide passage 330, and flows into the assembled battery case 80 cools or warms up the respective batteries of the assembled battery 8, the blast air is discharged to the vehicle exterior or flows into the vehicle interior.

A temperature regulating door 33 is disposed on an upstream side of the air flow in the battery guide passage 330. The temperature regulating door 33 fully opens or closes the battery guide passage 330, and also regulates an opening area of the battery guide passage 330. The temperature regulating door 33 may be used as an example of a temperature-regulation object switching device for switching whether to provide the temperature regulated air to the assembled battery 8 which is an example of the electric device. The temperature regulating door 33 is coupled with an electric actuator for driving the battery temperature regulating door through a link mechanism, and rotates in conjunction with the electric actuator. The operation of the electric actuator is controlled according to the control signal output from the control device 100.

The assembled battery 8 is provided with a battery temperature sensor 11 for detecting the temperature of the electric cells. The battery temperature sensor 11 is an example of a device temperature detection device for detecting a temperature of the temperature regulation object. The battery temperature sensor 11 can be configured to detect a surface temperature of a predetermined electric cell, a temperature of the electrode terminal, or a temperature of the bus bar.

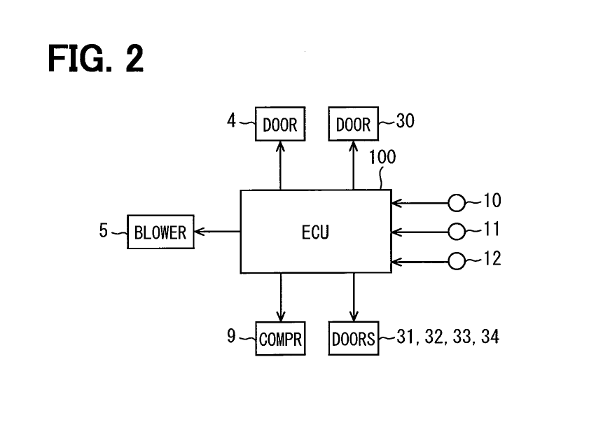

As illustrated in FIG. 2, the control device 100 receives detection signals from the temperature/humidity sensor 10, the battery temperature sensor 11, and the humidity sensor 12. The control device 100 controls the operation such as the rotating speed of the compressor 9 (COMPR), opening positions of the respective doors 4, 30, and 31 to 34, and the rotating speed of the indoor blower 5 according to calculation results using calculation programs stored in a calculation unit or a storage device in advance.

The control device 100 controls the operation of the vehicle air conditioning apparatus 2 according to temperature information detected by the temperature detection device (battery temperature sensor 11) and humidity information detected by the humidity detection device (temperature/humidity sensor 10, humidity sensor 12). When conditions for implementing the battery warming-up operation to warm the assembled battery 8 by blowing the hot air are established in the temperature regulation control of the battery, the control device 100 controls the respective doors 4, 30, 31 to 34, the indoor blower 5, the compressor 9, and the refrigerant circuit switching means (electromagnetic valve, etc.) to implement the battery warming-up operation. When conditions for implementing the battery cooling operation to cool the assembled battery 8 by blowing the cold air are established, the control device 100 controls the respective doors 4, 30, 31 to 34, the indoor blower 5, the compressor 9, and the refrigerant circuit switching means (electromagnetic valve, etc.) to implement the battery cooling operation.

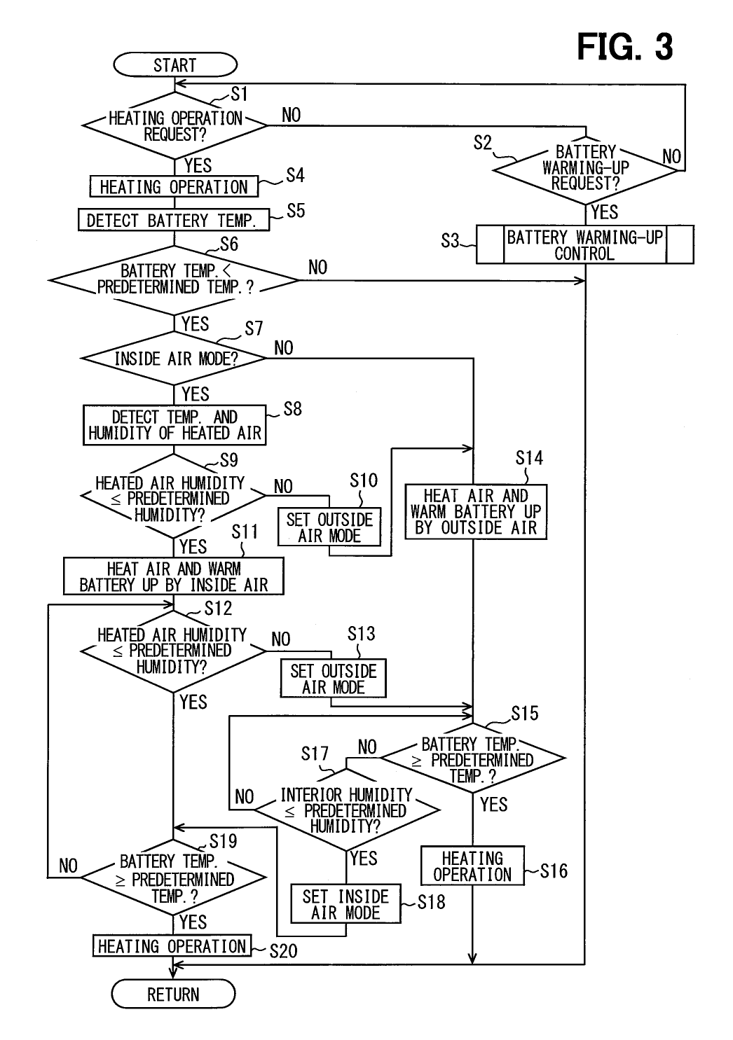

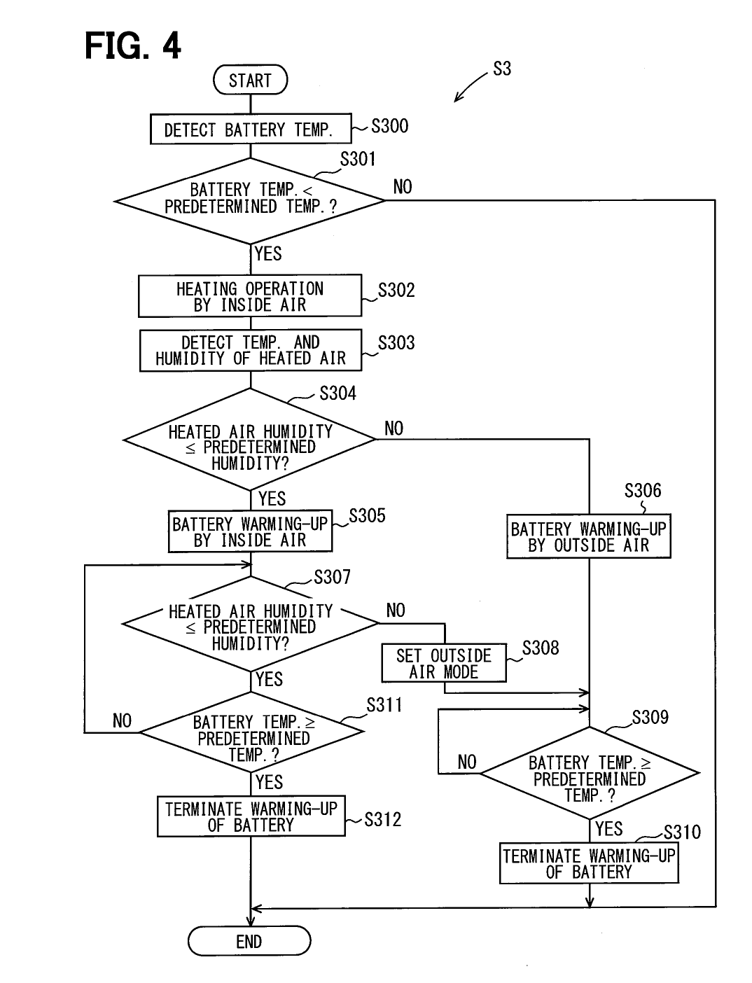

Subsequently, a description will be given of a processing procedure of a temperature regulation control involved in the vehicle interior heating operation and the battery warming-up operation in the temperature regulation control to be implemented by the temperature regulating device 1 with reference to flowcharts of FIGS. 3 and 4. A sub-routine illustrated in FIG. 4 is applied to, for example, a case in which preliminary battery warm-up for heating the battery in advance before charging is performed in charging at night.

Flowcharts in FIGS. 3 and 4 are mainly executed by the control device 100. The temperature regulation control involved in the vehicle interior heating operation and the battery warming-up operation starts when a start switch (for example, ignition switch) of the vehicle is set to an on-state, or when the air conditioning ECU is powered.

The temperature regulation control may start in the following situations. For example, the temperature regulation control starts when a time set by the user of the vehicle arrives, when a predetermined time elapses from the time set by the user of the vehicle, and when a start command is issued by a predetermined user's operation (for example, the operation while getting in the vehicle or before getting in the vehicle is made). In the case where a secondary battery of the vehicle is charged at night, the temperature regulation control may start when the time automatically or manually set arrives, or when a time going back a predetermined period of time from the set time arrives. Further, the temperature regulation control may start when a start time obtained from past performances or a charge start time arrives.

As illustrated in FIG. 3, it is determined whether there is a request for the heating operation for heating the vehicle interior, or not, in Step S1. It is determined that there is the request for the heating operation when a request signal for performing the heating air conditioning in the vehicle interior is input to the control device 100 by manual setting, or when conditions for implementing the heating air conditioning in the vehicle interior are established by the calculation of the control device 100 during setting automatic air conditioning operation.

If it is determined that there is the request for the heating operation in Step S1, the flow proceeds to Step S4. If it is determined that there is no request for the heating operation in Step S1, it is determined whether there is the request for warming up the battery, or not, in Step S2. It is determined that there is the request for warming up the battery for the purpose of maintaining the temperature of the battery which is an example of the electric device within a predetermined temperature range (equal to or higher than 10° C. and equal to or lower than 40° C.) for optimum operation when the battery temperature is lower than the predetermined temperature (lower than 10° C.) when the battery is charged or discharged. The battery temperature is obtained according to the detection signal of the battery temperature sensor 11 which is input to the control device 100.

If it is determined that there is no request for warming up the battery in Step S2, the flow returns to Step S1. If it is determined that there is the request for warming up the battery in Step S2, the flow returns to Step S1 after the warm-up control of the battery in Step S3 has been executed, and the process in this flow chart is repetitively executed. The warm-up control of the battery is executed according to the subroutine illustrated in FIG. 4.

When there is the heating request, the heating operation starts in Step S4. In the heating operation, the inside air mode or the outside air mode is implemented according to an air intake mode manually set, or an air intake mode set in the automatic air conditioning operation, and the air heated by the condenser 7 is blown into the vehicle interior through the foot passage 340. As an example, FIG. 1 illustrates the heating operation of the inside air mode for providing a heating air from the foot air outlet in the vehicle interior, in the inside air mode for circulating the air in the vehicle interior

Then, the battery temperature (for example, detected by the battery temperature sensor 11) at the predetermined position of the assembled battery 8 is detected in Step S5. It is determined whether the detected battery temperature is lower than the predetermined temperature, or not, in Step S6. The predetermined temperature is stored in the control device 100 in advance. For example, 10° C. can be set as the predetermined temperature. Step S6 is a step of determining whether the conditions for implementing the battery warming-up operation are established, or not. Therefore, when the determination is yes in Step S6, the operation of a mode for heating the battery is executed according to the processing of the subsequent steps. If the determination is no in Step S6, this flowchart is terminated. Or, when the cooling conditions of the battery are established, a mode for cooling the battery is executed.

If it is determined that the conditions for implementing the warming-up operation are established in Step S6 (yes), it is determined whether the inside air mode is set in the heating operation under implementation, or not, in subsequent

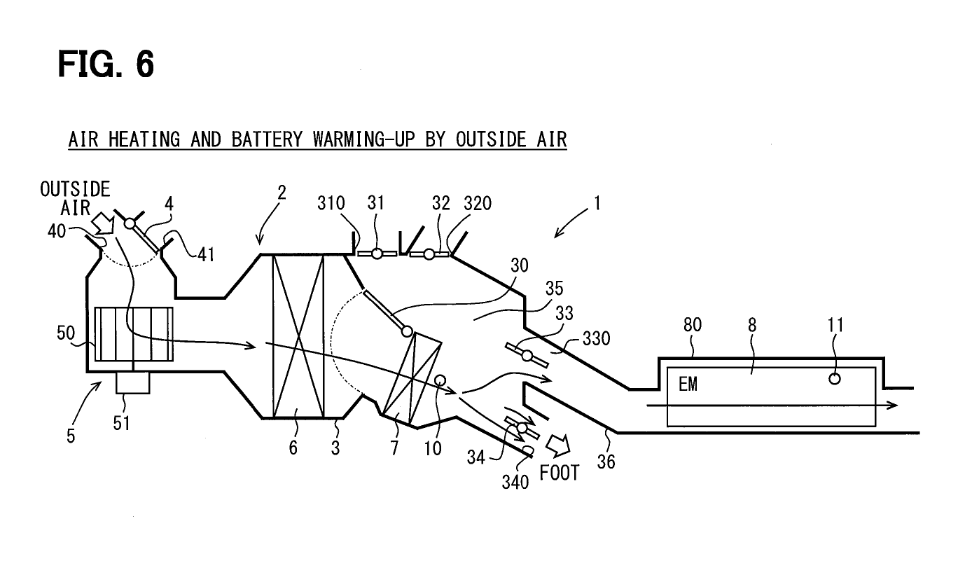

Step S7. If it is determined that the inside air mode is not set in Step S7, the heating in the vehicle interior and the operation in the battery warm-up start in the outside air mode in Step S14. In the operation mode, the respective components are controlled, for example, as illustrated in FIG. 6.

In other words, the control device 100 sets the refrigerant circuit for the heating operation by the driving of the compressor 9 and the control of the refrigerant circuit switching means, and also controls the position of the inside/outside air switching door 4 to open the outside air inlet port 40 and close the inside air inlet port 41, and drives the indoor blower 5. Further, the control device 100 controls the air mix door 30 to be at a maximum heating position, and controls the defroster door 31 and the face door 32 to be at positions where the defroster passage 310 and the face passage 320 are closed. Further, the control device 100 controls the foot door 34 and the temperature regulating door 33 to be at positions where the foot passage 340 and the battery guide passage 330 are opened. With the above control, after the outside air drawn into the vehicle air conditioning apparatus 2 has been heated by the condenser 7, the outside air branches into the foot passage 340 and the battery guide passage 330, is supplied to the vehicle interior as the heating air, and also blown to the assembled battery 8 to heat and warm up the battery.

Subsequently, it is determined whether the battery temperature is equal to or higher than a predetermined temperature, or not, in Step S15. The predetermined temperature in this case is the same as the predetermined temperature in Step S6. If it is determined that the battery temperature is equal to or higher than the predetermined temperature in Step S15, it is determined that the warm-up of the battery is completed by the implementation of the operation in Step S14, and the warming-up operation of the battery is terminated in Step S16. Therefore, only the heating operation in the vehicle interior (the heating operation in the vehicle interior in the outside air mode) is implemented in Step S16, the flow returns to Step S1, and the processing in this flowchart is repetitively executed.

If it is determined that the battery temperature is not equal to or higher than the predetermined temperature in Step S15, it is then determined whether the humidity in the vehicle interior is equal to or lower than a predetermined humidity, or not, in Step S17. The humidity in the vehicle interior can be detected by the humidity sensor 12. The predetermined humidity is an upper limit of the humidity with which it can be confirmed that the dew condensation is not generated on the battery when the vehicle interior air is heated, and then blown to the assembled battery 8. If the vehicle interior air exceeds the predetermined humidity, the dew condensation is likely to be generated on the battery. The upper limit is a humidity determined through confirmation tests based on various environmental conditions in various electric devices to be warmed up, and stored in the control device 100 in advance.

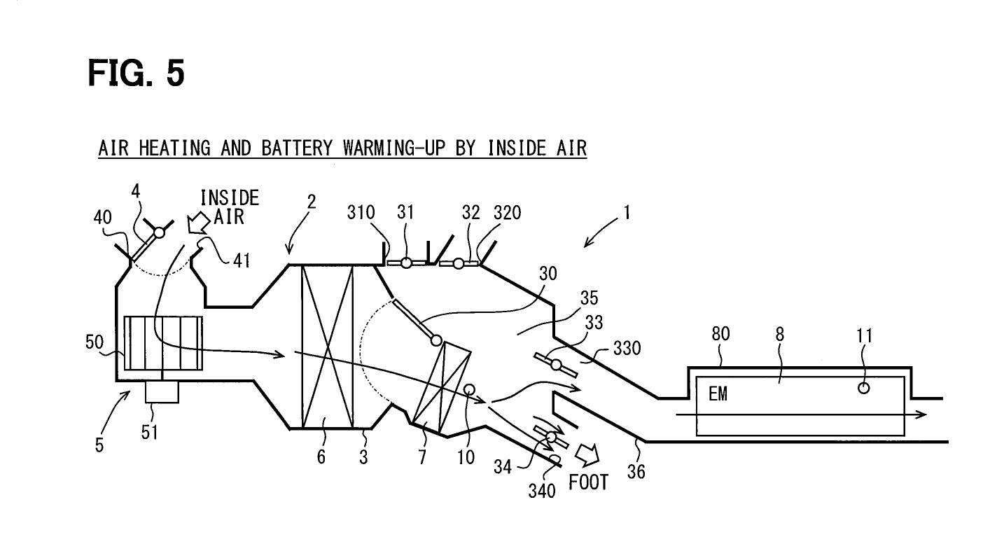

If it is determined that the vehicle interior air is not equal to or lower than the predetermined humidity in Step S17, the flow returns to Step S15. If it is determined that the vehicle interior air is equal to or lower than the predetermined humidity in Step S17, the mode is set to the inside air mode in Step S18, and the flow proceeds to Step S19. In other words, the heating in the vehicle interior and the operation of the battery warm-up start in the inside air mode in Step S18. In the operation mode, the respective components are controlled, for example, as illustrated in FIG. 5.

In other words, the control device 100 controls the position of the inside/outside air switching door 4 so as to close the outside air inlet port 40 and open the inside air inlet port 41 unlike the operation illustrated in FIG. 6. With the above control, after the inside air drawn into the vehicle air conditioning apparatus 2 has been heated by the condenser 7, the inside air branches into the foot passage 340 and the battery guide passage 330, is supplied to the vehicle interior as the heating air, and also blown to the assembled battery 8 to heat and warm up the battery.

If it is determined that the mode is set to the inside air mode in Step S7 described above, the humidity of the air blown to the assembled battery 8 is detected in Step S8. In this example, the temperature and the humidity of the air that has passed through the condenser 7 are detected by the temperature/humidity sensor 10. It is determined whether the humidity of the air blown to the assembled battery 8 (electric device) is equal to or lower than the predetermined humidity, or not, in Step S9. The predetermined humidity is an upper limit of the humidity with which it can be confirmed that the dew condensation is not generated on the battery when the air that has been heated by the condenser 7 is blown to the assembled battery 8. If the humidity detected by the temperature/humidity sensor 10 exceeds the predetermined humidity, the dew condensation is likely to be generated on the battery. The upper limit is a humidity determined through confirmation tests based on various environmental conditions in various electric devices to be warmed up, and stored in the control device 100 in advance.

If it is determined that the air blown to the assembled battery 8 is not equal to or lower than the predetermined humidity in Step S9, the dew condensation is likely to be generated on the battery with the inside air mode kept as it is. For that reason, in order to take in the outside air low in the humidity, the mode is set to the outside air mode in Step S10, and the flow proceeds to Step S14 described above. In other words, the inside air mode is changed to the outside air mode, and the heating in the vehicle interior and the operation of the battery warm-up are implemented in Step S10. In the operation mode, the respective components are controlled, for example, as illustrated in FIG. 6.

If it is determined that the air blown to the assembled battery 8 is equal to or lower than the predetermined humidity in Step S9, the inside air mode is maintained, and the heating in the vehicle interior and the operation in the battery warm-up start in the inside air mode in Step S11. In the operation mode, the respective components are controlled, for example, as illustrated in FIG. 5.

In other words, the control device 100 controls the position of the temperature regulating door 33 so as to open the battery guide passage 330 unlike the operation illustrated in FIG. 1. With the above control, after the inside air drawn into the vehicle air conditioning apparatus 2 has been heated by the condenser 7, the inside air branches into the foot passage 340 and the battery guide passage 330, is supplied to the vehicle interior as the heating air, and also blown to the assembled battery 8 to heat and warm up the battery.

It is then determined whether the humidity of the air blown to the assembled battery 8 (electric device) is equal to or lower than the predetermined humidity, or not, in Step S12. In Step S12, the same determination as that in Step S9 is performed. If it is determined that the air blown to the assembled battery 8 is not equal to or lower than the predetermined humidity in Step S12, the dew condensation is likely to be generated on the battery with the inside air mode kept as it is. For that reason, in order to draw the outside air low in the humidity, the mode is set to the outside air mode in Step S13, and the flow proceeds to Step S15 described above. In other words, the inside air mode is changed to the outside air mode, and the heating in the vehicle interior and the operation of the battery warm-up are implemented in Step S13.

If it is determined that the air blown to the assembled battery 8 is equal to or lower than the predetermined humidity in Step S12, because the dew condensation is unlikely to be generated on the battery, the inside air mode is continued. It is then determined whether the battery temperature detected by the battery temperature sensor 11 is equal to or higher than the predetermined temperature, or not, in Step S19. The predetermined temperature is the same as the predetermined temperature in Step S6 described above. If it is determined that the battery temperature is equal to or higher than the predetermined temperature in Step S19, it is determined that the warm-up of the battery is completed by the implementation of the battery warming-up operation in the inside air mode, and the warming-up operation of the battery is terminated in Step S20. Therefore, only the heating operation in the vehicle interior (the heating operation in the vehicle interior in the inside air mode) is implemented in Step S20, the flow returns to Step S1, and the processing in this flowchart is repetitively executed.

If it is determined that the battery temperature is not equal to or higher than the predetermined temperature in Step S19, the flow returns to Step S12, and the battery warming-up operation is continuously continued. The detected humidity used in the determination of Steps S9 and S12 may be a value detected in the humidity sensor 12 as in Step S17.

Subsequently, a description will be given of the battery warm-up control when there is no heating request in Step S3 described above with reference to the subroutine illustrated in FIG. 4.

As illustrated in FIG. 4, the battery temperature (for example, detected by the battery temperature sensor 11) at the predetermined position of the assembled battery 8 is detected in Step S300 as in Step S5 described above. It is then determined whether the battery temperature detected in Step S300 is lower than the predetermined temperature, or not, in Step S301. The predetermined temperature is identical with the predetermined temperature in Step S6. If the determination is yes in Step S301, the operation of a mode for heating the battery is executed without performing the heating in the vehicle interior according to the processing of the subsequent steps. If the determination is no in Step S301, the subroutine is terminated, and the flow returns to Step S1 in FIG. 3.

If it is determined that the conditions for implementing the warming-up operation are established in Step S301 (yes), the heating operation in the inside air mode illustrated in FIG. 1 is implemented in subsequent Step S302. Then, the humidity of the air blown to the assembled battery 8 is detected in Step S303. In this example, the temperature and the humidity of the air that has passed through the condenser 7 are detected by the temperature/humidity sensor 10. Alternatively, the humidity in the vehicle interior may be detected by the humidity sensor 12.

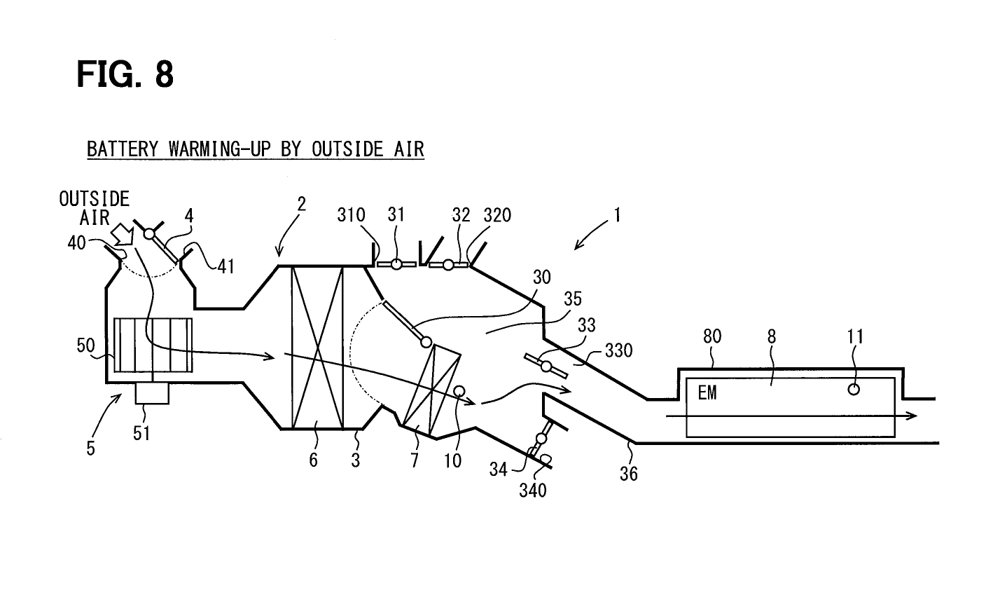

It is then determined whether the humidity of the air detected by the temperature/humidity sensor 10 is equal to or lower than the predetermined humidity, or not, in Step S304. In Step S304, the same determination as that in Step S9 described above is performed. If it is determined that the air blown to the assembled battery 8 is not equal to or lower than the predetermined humidity in Step S304, the dew condensation is likely to be generated on the battery when the air is blown to the assembled battery 8 with the inside air mode kept as it is. For that reason, in order to take in the outside air low in the humidity, the operation of the battery warm-up in the outside air mode is implemented in Step S306. In the operation mode, the respective components are controlled, for example, as illustrated in FIG. 8.

In other words, the control device 100 sets the refrigerant circuit for the heating operation by the driving of the compressor 9 and the control of the refrigerant circuit switching means, and also controls the position of the inside/outside air switching door 4 to open the outside air inlet port 40 and close the inside air inlet port 41, and drives the indoor blower 5. Further, the control device 100 controls the air mix door 30 to be at a maximum heating position, and controls the defroster door 31, the face door 32, and the foot door 34 to be at positions where the defroster passage 310, the face passage 320, and the foot passage 340 are closed. Further, the control device 100 controls the temperature regulating door 33 to be at a position where the battery guide passage 330 is opened. With the above control, after the outside air taken into the vehicle air conditioning apparatus 2 has been heated by the condenser 7, the outside air flows into only the battery guide passage 330, and blown to the assembled battery 8 to heat and warm up the battery.

Subsequently, it is determined whether the battery temperature is equal to or higher than a predetermined temperature, or not, in Step S309. In that step, the same determination as that in Step S6 is performed. Step S309 is repeated until it is determined that the battery temperature is equal to or higher than the predetermined temperature. If it is determined that the battery temperature is equal to or higher than the predetermined temperature in Step S309, it is determined that the warm-up of the battery is completed by the implementation of the operation in Step S306, the warming-up operation of the battery is terminated in Step S310, the subroutine is terminated, and the flow returns to Step S1 in FIG. 3.

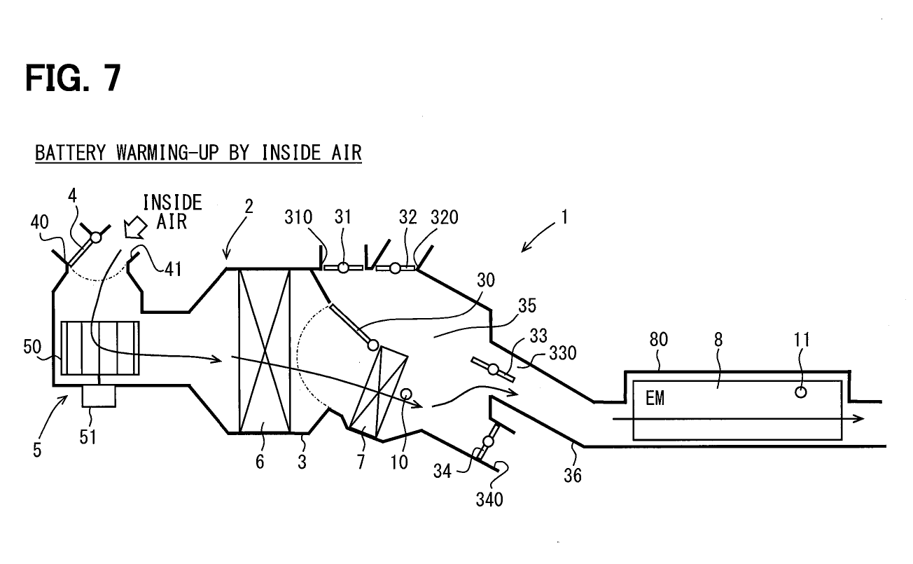

If it is determined that the humidity detected by the temperature/humidity sensor 10 is equal to or lower than the predetermined humidity in Step S304, the inside air mode is maintained, and the operation in the battery warm-up in the inside air mode starts in Step S305. In the operation mode, the respective components are controlled, for example, as illustrated in FIG. 7.

In other words, the control device 100 controls the positions of the foot door 34 and the temperature regulating door 33 so as to close the foot passage 340 and open the battery guide passage 330 unlike the operation illustrated in FIG. 1. With the above control, after the inside air drawn into the vehicle air conditioning apparatus 2 has been heated by the condenser 7, the inside air flows into only the battery guide passage 330, and blown to the assembled battery 8 to heat and warm up the battery.

It is then determined whether the humidity of the air blown to the assembled battery 8 (electric device) is equal to or lower than the predetermined humidity, or not, in Step S307. In Step S307, the same determination as that in Step S12 is performed. If it is determined that the air blown to the assembled battery 8 is not equal to or lower than the predetermined humidity in Step S307, the dew condensation is likely to be generated on the battery with the inside air mode kept as it is. For that reason, in order to draw the outside air low in the humidity, the mode is set to the outside air mode in Step S308, and the flow proceeds to Step S309 described above. In other words, the inside air mode is changed to the outside air mode, and the operation of the battery warm-up is implemented in Step S308.

If it is determined that the air blown to the assembled battery 8 is equal to or lower than the predetermined humidity in Step S307, because the dew condensation is unlikely to be generated on the battery, the inside air mode is continued. It is then determined whether the battery temperature detected by the battery temperature sensor 11 is equal to or higher than the predetermined temperature, or not, in Step S311. The predetermined temperature is the same as the predetermined temperature in Step S6 described above. If it is determined that the battery temperature is equal to or higher than the predetermined temperature in Step S311, it is determined that the warm-up of the battery is completed by the implementation of the battery warming-up operation in the inside air mode, the subroutine is terminated with the termination of the warming-up operation of the battery in Step S312, and the flow returns to Step S1 in FIG. 3.

In the heating operation in the vehicle interior, the operation of the vehicle interior heating and the battery warm-up in the inside air mode, and the operation of the vehicle interior heating and the battery warm-up in the outside air mode illustrated in FIGS. 1, 5 and 6, the vent mode into the vehicle interior is set to the foot mode. In those respective operations, the vent mode may be set to another mode such as a foot and defroster mode or a foot and face mode according to the heating operation in the vehicle interior.

The operational advantages of the temperature regulating device 1 according to the first embodiment will be described below. When it is determined that the warming-up operation of the electric device (assembled battery 8) is necessary, when the humidity of the air detected by the humidity detection device is equal to or lower than the predetermined humidity, the temperature regulating device 1 heats the vehicle interior air (inside air), and blows the heated air toward the electric device through the communication passage (battery guide passage 330) (S11, S305). If the detected humidity of the air exceeds the predetermined humidity, the temperature regulating device 1 heats the vehicle exterior air (outside air), and blows the heated air toward the electric device through the communication passage (S10, S13, S306, S308).

According to the above configuration, in the warming-up operation of the electric device, when the humidity of the inside air is high, the outside air that can be assumed to be lower in humidity than the inside air is blown to the electric device. Further, when the humidity of the inside air is not high, the inside air which can be assumed to be higher in the humidity than the outside air is blown to the electric device. With the above configuration, the warming-up operation that can suppress the generation of the dew condensation in the electric device can be implemented. The generation of the dew condensation in the electric device is caused by blowing the inside air higher in humidity than the outside air due to breath and sweating of the occupant. Further, the warming-up operation that can suppress a reduction in the heating efficiency caused by heating and blowing the outside air can be implemented. This makes it possible to suppress the dew condensation of the electric device and secure the heating efficiency in implementing the warming-up operation on the electric device with the use of the conditioned air caused by the vehicle air conditioning apparatus 2.

In particular, when the temperature regulating device 1 is applied to a hybrid vehicle, a device that contributes to an improvement in regenerative energy in winter can be provided because the dew condensation of the electric device such as the battery can be suppressed, and the efficient warm-up can be implemented.

According to the temperature regulating device 1, the condenser 7 included in the air conditioning refrigerant cycle is employed as the heating heat exchanger, and the evaporator 6 included in the air conditioning refrigerant cycle is employed as the cooling exchanger. This makes it possible to provide the device that can execute the battery warming-up operation, the battery cooling operation, the heating/battery warming-up operation, and the cooling/battery cooling operation with the use of the refrigerant cycle for the vehicle interior air conditioning.

Further, according to the temperature regulating device 1, when the temperature regulated air is in the inside air mode of a situation where the possibility of the dew condensation is extremely low, an inflow of dust and humidity (rainy weather) from an external of the vehicle can be suppressed, and a heat loss of the temperature regulated air can be reduced. As a result, a device of power saving can be provided.

Because the temperature regulation object is a secondary battery for storing an electric power for vehicle travel, the effective temperature regulation control can be implemented while the dew condensation is prevented in the device where a temperature range in which main functions (charging, discharging, etc.) of the battery can be exerted is determined.

If the humidity of the air from the vehicle interior exceeds the predetermined humidity (S12, S307) during the operation of heating the vehicle interior air, and blowing the heated air to the electric device through the communication passage, the control device 100 switches from the above operation to the operation of heating the vehicle exterior air, and blowing the heated air to the electric device through the communication passage (S13, S308).

According to the above configuration, when it is determined that the inside air has such a humidity that the dew condensation is likely to be generated even during the warming-up operation of heating the vehicle interior air (inside air) and blowing the heated air toward the electric device, reliable dew condensation prevention can be executed by switching from the inside air supply to the outside air supply. As described above, the humidity level of the air blown to the electric device is monitored, and measures against the dew condensation are taken in advance when the dew condensation is likely to be generated. This makes it possible to ensure the securement of the high warm-up capability and the stable dew condensation prevention control.

If the humidity of the vehicle interior air is equal to or lower than the predetermined humidity (S17) during the operation of heating the vehicle exterior air, and blowing the heated air to the electric device through the communication passage, the control device 100 switches from the above operation to the operation of taking and heating the vehicle interior air, and blowing the heated air to the electric device through the communication passage (S18).

According to the above configuration, when it is determined that the inside air has such a humidity that the dew condensation is unlikely to be generated even during the warming-up operation of heating the vehicle exterior air (outside air) and blowing the heated air toward the electric device, the outside air supply is switched to the inside air supply. With the above operation, when the inside air is higher in temperature than the outside air, because the inside air higher in heating efficiency than the outside air is used for the warming-up operation, the warming-up operation can be terminated earlier. As described above, the humidity level of the air blown to the electric device is monitored, and when there is no possibility of dew condensation, the inside air is positively heated and used for warm-up of the electric device. This makes it possible to provide the warming-up operation that improves the heating efficiency with the ensuring of the dew condensation prevention.

Further, in the case of an inside air circulation mode in which the inside air is circulated between the vehicle interior and the electric device while being heated, after the inside air that has been heated once is used for warm-up of the electric device, the inside air is again heated and then used for warm-up. As a result, the warming-up operation smaller in heating loss than a case using the outside air can be implemented.

### Second Embodiment

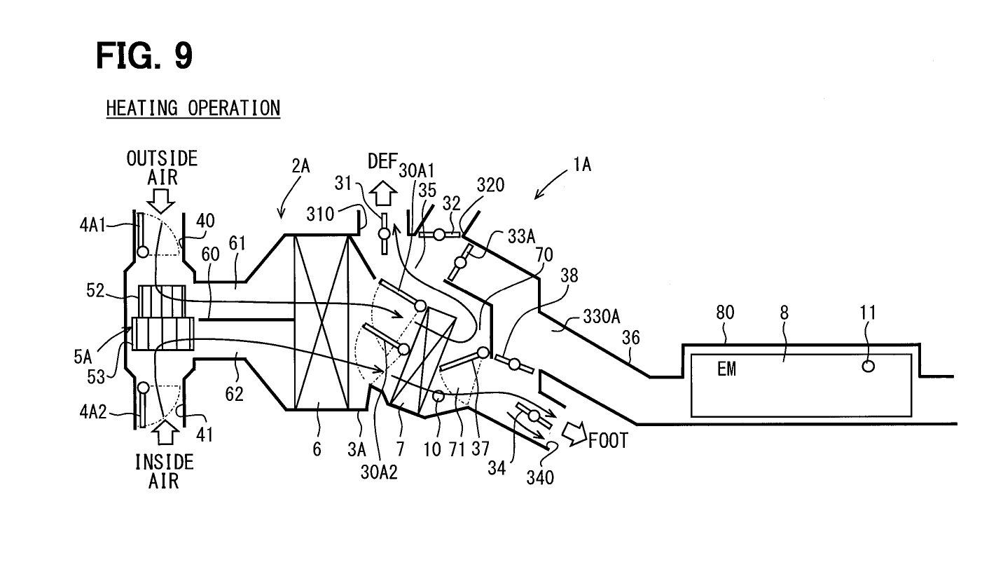

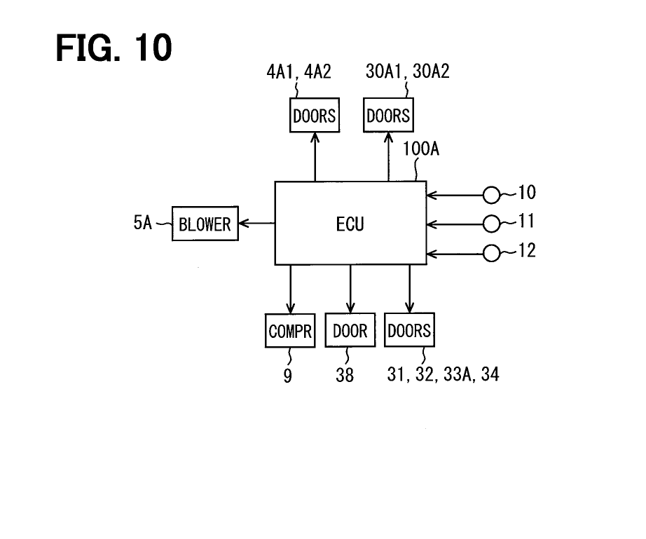

In a second embodiment, a temperature regulating device 1A according to another configuration to the first embodiment will be described with reference to FIGS. 9 to 16. In each of FIGS. 9 and 10, components denoted by the same symbols as those referred to in the first embodiment represent identical components, and their operational advantages are also identical with those in the first embodiment. Hereinafter, a description will be given of a configuration, a processing procedure, and operation different from those in the first embodiment. Therefore, configurations, operation, and effects not described are identical with those described in the first embodiment. FIG. 9 illustrating a configuration of the temperature regulating device 1A illustrates an operating state of the temperature regulating device 1A during heating operation for heating a vehicle interior.

As illustrated in FIG. 9, the temperature regulating device 1A is different from the temperature regulating device 1 of the first embodiment in that a vehicle air conditioning apparatus 2A is an air conditioning apparatus of an inside-outside-air two-layered type. The vehicle air conditioning apparatus 2A of the inside-outside-air two-layered type includes an outside air introduction passage 61 in which a vehicle exterior air drawn from the vehicle exterior flows, and an inside air introduction passage 62 in which a vehicle interior air drawn from the vehicle interior flows, as passages independent from each other.

An inside/outside air switching device of the temperature regulating device 1A includes an outside air door 4A1 that opens and closes an outside air inlet port 40, and an inside air door 4A2 that opens and closes an inside air inlet port 41. The respective doors that configure the inside/outside air switching device are doors for opening and closing the corresponding outside air inlet port 40 and inside air inlet port 41, individually.

An indoor blower 5A is disposed downstream of the inside/outside air switching device in the air flow. The indoor blower 5A blows the air drawn through the inside/outside air switching device toward the vehicle interior. The indoor blower 5A which is blowing means includes two centrifugal multi-blade fans 52 and 53. A suction part of the centrifugal multi-blade fan 52 communicates with the outside air inlet port 40. A suction part of the centrifugal multi-blade fan 53 communicates with the inside air inlet port 41. The respective fans are driven by an electric motor at the same time. An electric motor for driving both of the centrifugal multi-blade fans 52 and 53 is controlled in rotating speed (blowing rate) according to a control voltage output from a control device 100A. The respective fans may be configured to be driven by two electric motors, individually.

The outside air introduction passage 61 and the inside air introduction passage 62 are passages located downstream of the indoor blower 5A in the air flow. The outside air introduction passage 61 and the inside air introduction passage 62 are partitioned by a passage partition plate 60 disposed in a duct where the indoor blower 5A communicates with an evaporator 6. The passage partition plate 60 is installed to extend from blowing parts of the centrifugal multi-blade fan 52 and the centrifugal multi-blade fan 53 to a suction surface of a heat exchanging unit of the evaporator 6, and bisects a passage extending to the evaporator 6.

Two air mix doors 30A1 and 30A2 are disposed downstream of the evaporator 6 in the air flow. The air mix door 30A1 regulates a flow proportion of the flow rate passing through a condenser 7 to the flow rate not passing through the condenser 7 in the blast air that has passed through the evaporator 6 after flowing through the outside air introduction passage 61. The air mix door 30A2 regulates a flow proportion of the flow rate passing through the condenser 7 to the flow rate not passing through the condenser 7 in the blast air that has passed through the evaporator 6 after flowing through the indoor air introduction passage 62. The respective air mix doors 30A1 and 30A2 are driven by electric actuators for driving the air mix doors. The operation of the electric actuator is controlled according to a control signal output from the control device 100.

A diversion door 37 for dividing the outside air and the inside air which have been heated by the condenser 7 is disposed downstream of the condenser 7 in the air flow. The diversion door 37 bisects the passage located downstream of the condenser 7 in the air flow into an upper side passage 70 located on an upper side and a lower side passage 71 located on a lower side. The upper side passage 70 is a passage that communicates with an air mix unit 35 disposed further upward. The outside air that has passed through the condenser 7 reaches the air mix unit 35 from the upper side passage 70, and further flows toward the vehicle interior or an assembled battery 8 through a passage opened at that time among a defroster passage 310, a face passage 320, and a battery guide passage 330A.

The lower side passage 71 is a passage that further communicates with a foot passage 340 extending backward of the vehicle. The lower side passage 71 can communicate with the battery guide passage 330A under the control of an opening position of a communication door 38. The communication door 38 is a door disposed in a portion that communicates the battery guide passage 330 with the lower side passage 71. The communication door 38 is controlled by the control device 100A to be at a position where the battery guide passage 330 communicates with the lower side passage 71 or at a position where the communication between those passages is blocked. Therefore, the inside air that has passed through the condenser 7 flows toward the assembled battery 8 through the battery guide passage 330A when the communication door 38 communicates the lower side passage 71 with the battery guide passage 330A, and flows toward the vehicle interior through the foot passage 340 when a foot door 34 is present at an open position. The battery guide passage 330A is a passage formed by a guide duct 36 that couples an air conditioning case 3A with an assembled battery case 80.

In the heating operation in the vehicle interior illustrated in FIG. 9, the control device 100A sets the refrigerant circuit for the heating operation by the driving of a compressor 9 and the control of the refrigerant circuit switching means, and also controls the outside air door 4A1 to be at a position where the outside air inlet port 40 is opened, and controls the inside air door 4A2 to be at a position where the inside air inlet port 41 is opened. The control device 100A drives the electric motor to rotate the centrifugal multi-blade fan 52 and the centrifugal multi-blade fan 53, controls the air mix doors 30A1 and 30A2 to be at respective maximum heating positions, and controls the diversion door 37 to be at a position to branch a downstream side of the condenser 7 into the upper side passage 70 and the lower side passage 71. Further, the control device 100A controls a face door 32 and a temperature regulating door 33A to be at respective positions where the face passage 320 and the battery guide passage 330A are closed, and controls a defroster door 31 to be at a position where the defroster passage 310 is opened. Further, the control device 100A controls the communication door 38 to be at a position where the lower side passage 71 communicates with the battery guide passage 330A.

With the above configuration, after the outside air drawn into the vehicle air conditioning apparatus 2A has passed through the evaporator 6 through the outside air introduction passage 61, the outside air is heated by the condenser 7, flows into the defroster passage 310 through the upper side passage 70, and is supplied into the vehicle interior. After the inside air drawn into the vehicle air conditioning apparatus 2A has passed through the evaporator 6 through the inside air introduction passage 62, the inside air is heated by the condenser 7, flows into the foot passage 340 through the lower side passage 71, and is supplied into the vehicle interior.

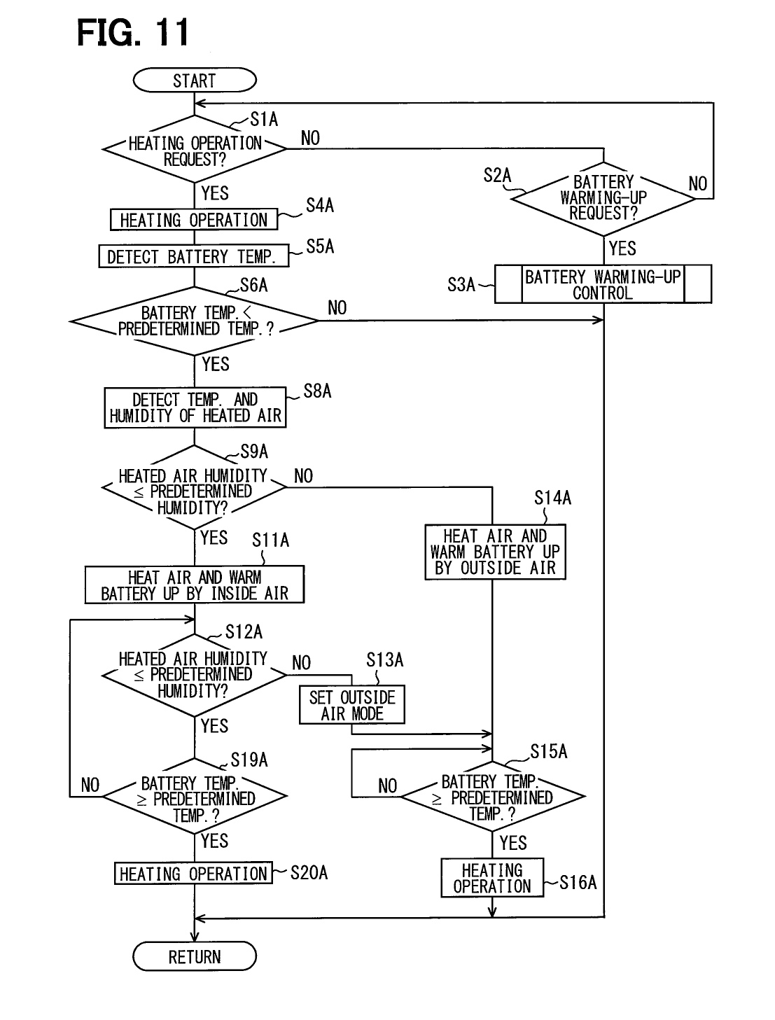

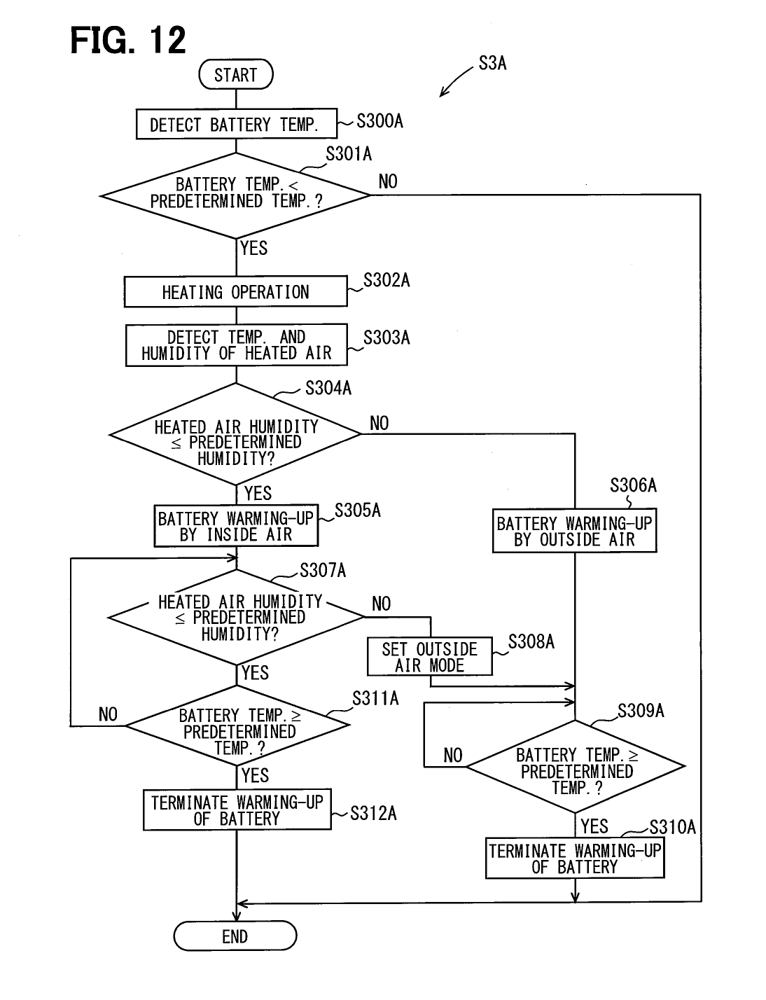

Subsequently, a description will be given of a processing procedure of a temperature regulation control involved in the vehicle interior heating operation and the battery warming-up operation in the temperature regulation control to be implemented by the temperature regulating device 1A with reference to flowcharts of FIGS. 11 and 12. A sub-routine illustrated in FIG. 12 is applied to, for example, a case in which preliminary battery warm-up for heating the battery in advance before charging is performed in charging at night.

Flowcharts in FIGS. 11 and 12 are mainly executed by the control device 100. Start conditions for the temperature regulation control involved in the vehicle interior heating operation and the battery warming-up operation are identical with those in the temperature regulation control described in the first embodiment with reference to FIGS. 3 and 4.

As illustrated in FIG. 11, it is determined whether there is a request for the heating operation for heating the vehicle interior, or not, in Step S1A. In Step S1A, the same determination as that in Step S1 of the first embodiment is performed.

If it is determined that there is the request for the heating operation in Step S1A, the flow proceeds to Step S4A. If it is determined that there is no request for the heating operation in Step S1A, it is determined whether there is the request for warming up the battery, or not, in Step S2A. In Step S2A, the same determination as that in Step S2 of the first embodiment is performed.

If it is determined that there is no request for warming up the battery in Step S2A, the flow returns to Step S1A. If it is determined that there is the request for warming up the battery in Step S2A, the flow returns to Step S1A after the warm-up control of the battery in Step S3A has been executed, and the process in this flow chart is repetitively executed. The warm-up control of the battery is executed according to the sub-routine illustrated in FIG. 12. When there is the heating request, the heating operation starts in Step S4A. In the heating operation, the operation illustrated in FIG. 9 is implemented as an example.

In Steps S5A and S6A, the same processes as those in Steps S5 and S6 of the first embodiment are performed, respectively. If the determination is no in Step S6A, this flowchart is terminated. If it is determined that implementation conditions of the warming-up operation are established in Step S6A (yes), the humidity after the inside air flowing through the inside air introduction passage 62 has been heated by the condenser 7 is then detected in Step S8A. In this example, the humidity of the air is detected by a temperature/humidity sensor 10 installed in the lower side passage 71. It is then determined whether the humidity of the air detected by the temperature/humidity sensor 10 is equal to or lower than the predetermined humidity, or not, in Step S9A. The same determination as that in Step S9 of the first embodiment is performed in Step S9A.

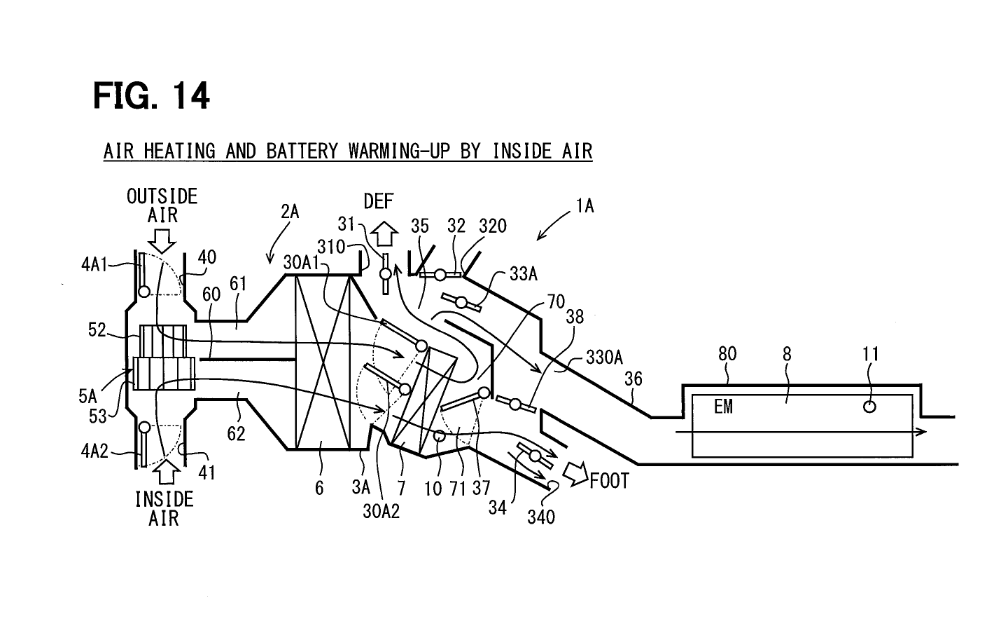

If it is determined that the detected humidity is not equal to or lower than the predetermined humidity in Step S9A, the dew condensation is likely to be generated on the battery when the inside air is blown to the assembled battery 8. For that reason, in order to draw the outside air low in the humidity, the vehicle interior heating and the battery warming-up operation for supplying the outside air are implemented in Step S14A. In the second warming-up operation, the respective components are controlled, for example, as illustrated in FIG. 14.

In other words, according to the second warming-up operation, the control device 100A sets the refrigerant circuit for the heating operation by the driving of the compressor 9 and the control of the refrigerant circuit switching means, and also controls the positions of the outside air door 4A1 and the inside air door 4A2 so as to open the outside air inlet port 40 and the inside air inlet port 41. The control device 100A drives the electric motor to rotate the centrifugal multi-blade fan 52 and the centrifugal multi-blade fan 53, controls the air mix doors 30A1 and 30A2 to be at respective maximum heating positions, and controls the diversion door 37 to be at a position to branch a downstream side of the condenser 7 into the upper side passage 70 and the lower side passage 71. Further, the control device 100A controls the face door 32 to be at a position where the face passage 320 is closed, and controls the defroster door 31 and the foot door 34 to be at positions where the defroster passage 310 and the foot passage 340 are opened. Further, the control device 100A controls the temperature regulating door 33A to be at a position where the battery guide passage 330A is opened, and controls the communication door 38 to be at a position to block a communication between the lower side passage 71 and the battery guide passage 330A.

With the above configuration, after the outside air drawn into the vehicle air conditioning apparatus 2A has passed through the evaporator 6 through the outside air introduction passage 61, the outside air is heated by the condenser 7, and divided into the defroster passage 310 and the battery guide passage 330A through the upper side passage 70. The heated outside air is divided and supplied to the vehicle interior as a heating air, and also blown to the assembled battery 8 to heat and warm up the battery. After the inside air drawn into the vehicle air conditioning apparatus 2A has passed through the evaporator 6 through the inside air introduction passage 62, the inside air is heated by the condenser 7, flows into the foot passage 340 through the lower side passage 71, and is supplied into the vehicle interior.

Subsequently, it is determined whether the battery temperature is equal to or higher than a predetermined temperature, or not, in Step S15A. The predetermined temperature in this case is the same as the predetermined temperature in Step S6 of the first embodiment. The determination in Step S15A is repeated until it is determined that the battery temperature is equal to or higher than the predetermined temperature. If it is determined that the battery temperature is equal to or higher than the predetermined temperature in Step S15A, it is determined that the warm-up of the battery is completed by the implementation of the operation in Step S14A, and the warming-up operation of the battery is terminated in Step S16A. Therefore, in Step S16A, the control device 100A controls the temperature regulating door 33A to be at a position to close the battery guide passage 330A, and supplies the outside air heated by the condenser 7 to only the vehicle interior. Then, the control device 100A returns to Step S1A, and repetitively executes the processing in this flowchart.

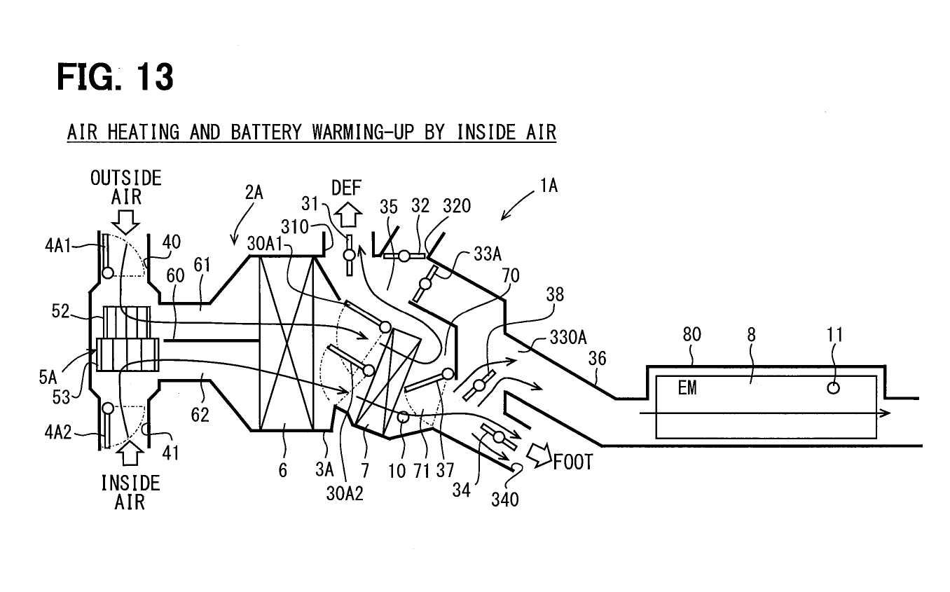

If it is determined that the detected humidity is equal to or lower than the predetermined humidity in Step S9A, the heating in the vehicle interior and the battery warming-up operation for supplying the inside air start in Step S11A. In the first warming-up operation, the respective components are controlled, for example, as illustrated in FIG. 13.

In other words, the first warming-up operation is different from the operation illustrated in FIG. 9 in that the control device 100 controls the communication door 38 to be at a position where the lower side passage 71 communicates with the battery guide passage 330A. With the above control, after the inside air drawn into the vehicle air conditioning apparatus 2A has been heated by the condenser 7, the inside air branches into the foot passage 340 and the battery guide passage 330A, is supplied to the vehicle interior as the heating air, and also blown to the assembled battery 8 to heat and warm up the battery.

Then, the same determination as that in Step S9A is performed in Step S12A. If it is determined that the detected humidity is not equal to or lower than the predetermined humidity in Step S12A, the dew condensation is likely to be generated on the battery when the inside air is blown to the assembled battery 8. For that reason, in order to take in the outside air low in the humidity, the mode is set to an outside air mode for blowing the outside air to the battery in Step S13A, and the flow proceeds to Step S15A described above. In other words, the operation used to blow not the inside air but the outside air to the battery is implemented in Step S13A. In the operation mode, the respective components are controlled, for example, as illustrated in FIG. 14.

If it is determined that the detected humidity is equal to or lower than the predetermined humidity in Step S12A, because the dew condensation is unlikely to be generated on the battery, the operation used to blow the inside air to the battery is continued. It is then determined whether the battery temperature detected by a battery temperature sensor 11 is equal to or higher than the predetermined temperature, or not, in Step S19A. The same determination as that in Step S19 of the first embodiment is performed in Step S19A. If it is determined that the battery temperature is not equal to or higher than the predetermined temperature in Step S19A, the flow returns to Step S12A, and the battery warming-up operation is continuously continued.

If it is determined that the battery temperature is equal to or higher than the predetermined temperature in Step S19A, it is determined that the warm-up of the battery is completed by the implementation of the battery warming-up operation using the inside air, and the warming-up operation of the battery is terminated in Step S20A. Therefore, in Step S20A, the control device 100A controls the temperature regulating door 33A to be at a position to close the battery guide passage 330A, and supplies the inside air heated by the condenser 7 to only the vehicle interior. Then, the control device 100A returns to Step S1A, and repetitively executes the processing in this flowchart.

Subsequently, a description will be given of the battery warm-up control when there is no heating request in Step S3A described above with reference to the subroutine illustrated in FIG. 12.

As illustrated in FIG. 12, in Steps S300A and S301A, the same determinations as those in Steps S300 and S301 of the first embodiment are performed, respectively. If the determination is no in Step S301A, the subroutine is terminated, and the flow returns to Step S1A in FIG. 11.

If it is determined that the conditions for implementing the warming-up operation are established in Step S301A (yes), the heating operation without implementing the battery warm-up as illustrated in FIG. 9 is implemented in subsequent Step S302A. Then, in Step S303A, the humidity of the inside air that has flowed out of the inside air introduction passage 62, and been heated by the condenser 7 is detected by the temperature/humidity sensor 10. It is then determined whether the humidity detected by the temperature/humidity sensor 10 is equal to or lower than the predetermined humidity, or not, in Step S304A. In Step S304A, the same determination as that in Step S304 of the first embodiment is performed.

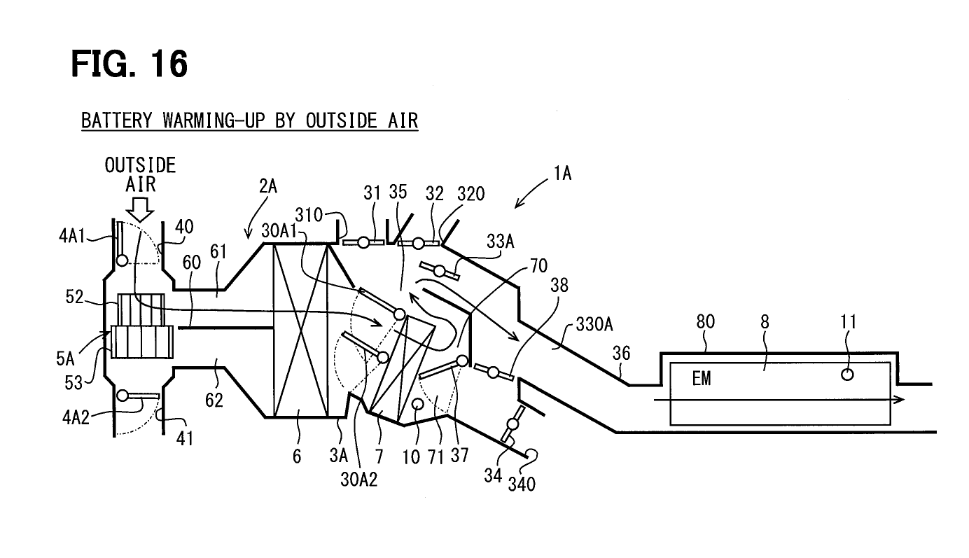

If it is determined that the detected humidity is not equal to or lower than the predetermined humidity in Step S304A, the dew condensation is likely to be generated on the battery when the inside air is blown to the assembled battery 8. For that reason, the battery warming-up operation for blowing only the outside air to the assembled battery 8 is implemented in Step S306A. In the operation mode, the respective components are controlled, for example, as illustrated in FIG. 16.

In other words, the control device 100A sets the refrigerant circuit for the heating operation by the driving of the compressor 9 and the control of the refrigerant circuit switching means, and also controls the outside air door 4A1 and the inside air door 4A2 at positions to open the outside air inlet port 40 and close the inside air inlet port 41. The control device 100A drives the electric motor to rotate at least the centrifugal multi-blade fan 52, controls the air mix doors 30A1 and 30A2 to be at respective maximum heating positions, and controls the diversion door 37 to be at a position to branch a downstream side of the condenser 7 into the upper side passage 70 and the lower side passage 71. Further, the control device 100A controls the defroster door 31, the face door 32, and the foot door 34 to be at respective positions to close the defroster passage 310, the face passage 320, and the foot passage 340. Further, the control device 100A controls the temperature regulating door 33A to be at a position where the battery guide passage 330A is opened, and controls the communication door 38 to be at a position to block a communication between the lower side passage 71 and the battery guide passage 330A.

In Step S309A, the same determination as that in Step S309 of the first embodiment is performed. Step S309A is repeated until it is determined that the battery temperature is equal to or higher than the predetermined temperature. If it is determined that the battery temperature is equal to or higher than the predetermined temperature in Step S309A, it is determined that the warm-up of the battery is completed by the implementation of the operation in Step S306A, the warming-up operation of the battery is terminated in Step S310A, the subroutine is terminated, and the flow returns to Step S1A in FIG. 11.

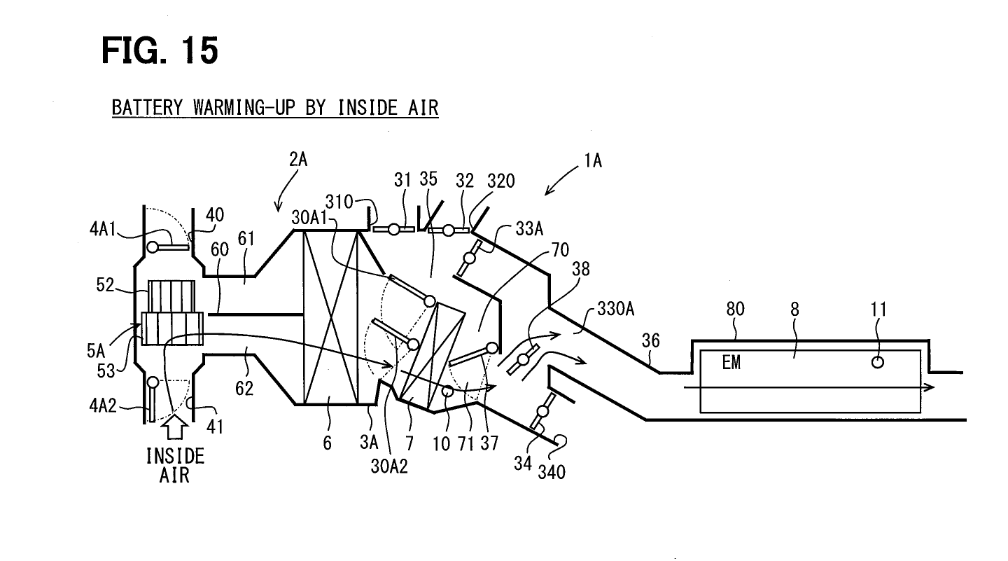

If it is determined that the humidity detected by the temperature/humidity sensor 10 is equal to or lower than the predetermined humidity in Step S304A, the battery warming-up operation for blowing only the inside air to the assembled battery 8 is implemented in Step S305A. In the operation mode, the respective components are controlled, for example, as illustrated in FIG. 15.

In other words, the control device 100A sets the refrigerant circuit for the heating operation, then opens the inside air inlet port 41, and controls the inside air door 4A2 and the outside air door 4A1 to be at positions to open the inside air inlet port 41 and close the outside air inlet port 40. The control device 100A drives the electric motor to rotate at least the centrifugal multi-blade fan 53, controls the air mix doors 30A1 and 30A2 to be at respective maximum heating positions, and controls the diversion door 37 to be at a position to branch a downstream side of the condenser 7 into the upper side passage 70 and the lower side passage 71. Further, the control device 100A controls the defroster door 31, the face door 32, and the foot door 34 to be at respective positions to close the defroster passage 310, the face passage 320, and the foot passage 340. Further, the control device 100A controls the temperature regulating door 33A to be at a position to close the battery guide passage 330A, and controls the communication door 38 to be at a position to permit a communication between the lower side passage 71 and the battery guide passage 330A.

Then, in Step S307A, the same determination as that in Step S304A described above is performed. If it is determined that the detected humidity is not equal to or lower than the predetermined humidity in Step S307A, the dew condensation is likely to be generated on the battery when the inside air is kept to be blown to the assembled battery 8. For that reason, the state is set to the operation of blowing the outside air to the assembled battery 8 in Step S308A, and the flow proceeds to Step S309A described above.

If it is determined that the detected humidity is equal to or lower than the predetermined humidity in Step S307A, because the dew condensation is unlikely to be generated on the battery, the operation in Step S305A is continued. Then, in Step S311A, the same determination as that in Step S309A described above is performed. If it is determined that the battery temperature is equal to or higher than the predetermined temperature in Step S311A, it is determined that the warm-up of the battery is completed by the implementation of the battery warming-up operation with the introduction of the inside air in Step S305A, the warming-up operation of the battery is terminated in Step S312A, the subroutine is terminated, and the flow returns to Step S1A in FIG. 11.

In the respective operation illustrated in FIGS. 9, 13, and 14, the vent mode into the vehicle interior is set to the foot mode. In those respective operations, the vent mode may be set to another mode such as a foot and defroster mode or a foot and face mode according to the heating operation in the vehicle interior.

According to the second embodiment described above, the temperature regulating device 1A includes the vehicle air conditioning apparatus 2A of the inside-outside-air two-layered type, and can implement the first warming-up operation and the second warming-up operation as operation of warming up the electric device. The first warming-up operation heats the vehicle exterior air (outside air) flowing out of the outside air introduction passage 61 to blow the heated air to the vehicle interior, and heats the vehicle interior air (inside air) flowing out of the inside air introduction passage 62 to blow the heated air to at least the electric device (assembled battery 8). The second warming-up operation heats the inside air flowing out of the inside air introduction passage 62 to blow the heated air to the vehicle interior, and heats the outside air flowing out of the outside air introduction passage 61 to blow the heated air to at least the electric device.

As described above, in the first warming-up operation, the outside air is heated and provided to the vehicle interior, and the inside air is heated and provided for warming up at least the electric device. In the second warming-up operation, the inside air is heated and provided to the vehicle interior, and the outside air is heated and provided for warming up at least the electric device.

According to the first warming-up operation, because the heated inside air is used for warm-up, a heating capacity can be suppressed as compared with a case of heating the outside air, and because the heated outside air is provided to the vehicle interior, the air low in humidity can be provided to the vehicle interior. Therefore, according to the first warming-up operation, both of the warm-up of the electric device high in the heating capacity and window anti-fog can be performed. According to the second warming-up operation, because the heated inside air is used for vehicle interior heating, the heating capacity can be suppressed as compared with a case of heating the outside air, and because the heated outside air is provided as the warm-up of the electric device, the dew condensation of the electric device can be suppressed by the air low in humidity. Therefore, according to the second warming-up operation, both of the vehicle interior heating high in the heating efficiency and the dew condensation suppression can be performed.

Further, in the first warming-up operation, the heated inside air is also blown to the vehicle interior, and in the second warming-up operation, the heated outside air is also blown to the vehicle interior. With the above configuration, according to the first warming-up operation, because the heated inside air is also used for vehicle interior heating, the vehicle interior heating high in the heating efficiency and the warm-up of the electric device can be implemented. According to the second warming-up operation, because the heated outside air is also provided to the vehicle interior, the air low in the humidity can be provided to the vehicle interior. Therefore, the window anti-fog and the dew condensation suppression of the electric device can be implemented.

If the humidity of the air from the vehicle interior exceeds the predetermined humidity (S12A, S307A) during the operation of heating the inside air, and blowing the heated air to the electric device (assembled battery 8) through the communication passage (battery guide passage 330A), the control device 100A switches from the above operation to the operation of heating the outside air, and blowing the heated air to the electric device through the communication passage (S13A, S308A).

According to the above configuration, when it is determined that the inside air has such a humidity that the dew condensation is likely to be generated even in the warming-up operation of heating the inside air and blowing the heated air to the electric device, the flow of the inside air into the communication passage is blocked, and the heated outside air that has flowed out of the outside air introduction passage 61 is allowed to flow into the communication passage. The reliable dew condensation prevention can be executed by switching the warm-up air. As described above, the humidity level of the air blown to the electric device is monitored, and measures against the dew condensation are taken in advance when the dew condensation is likely to be generated. This makes it possible to ensure the securement of the high warm-up capability and the stable dew condensation prevention control.

### Third Embodiment

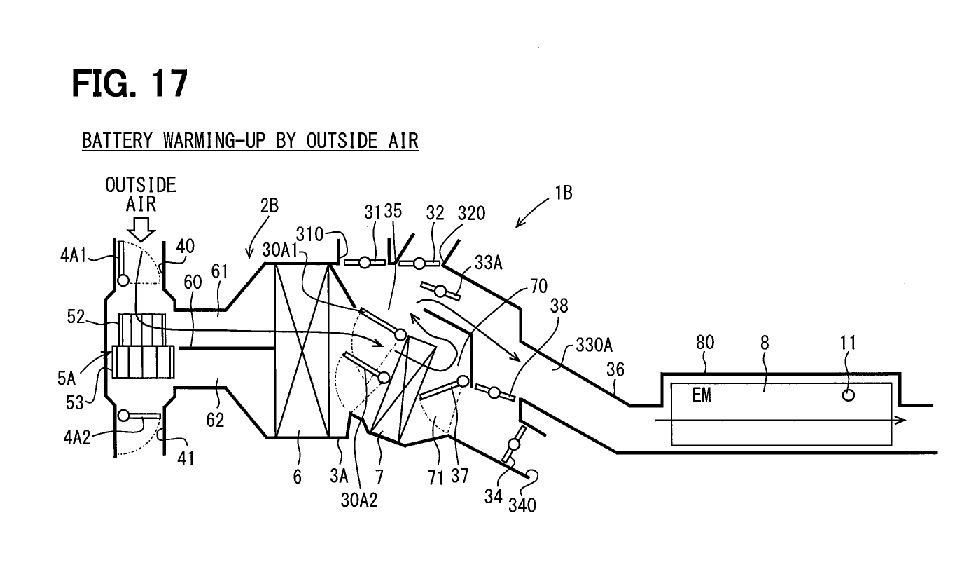

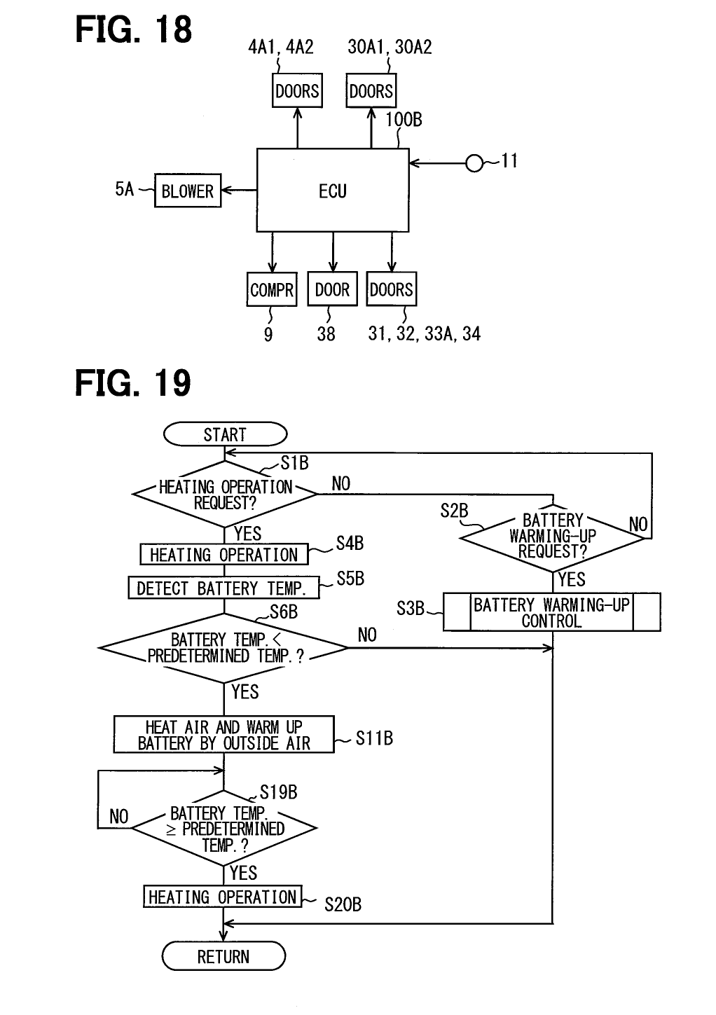

In the third embodiment, a temperature regulating device 1B according to another configuration to the second embodiment will be described with reference to FIGS. 17 to 22. In each of FIGS. 17 and 18, components denoted by the same symbols as those referred to in the second embodiment represent identical components, and their operational advantages are also identical with those in the second embodiment. Hereinafter, a description will be given of a configuration, a processing procedure, and operation different from those in the second embodiment. Therefore, configurations, operation, and effects not described are identical with those described in the second embodiment. FIG. 17 illustrating a configuration of the temperature regulating device 1B illustrates an operating state of the temperature regulating device 1B when warming up an assembled battery 8.

As illustrated in FIG. 17, the temperature regulating device 1B is different from the temperature regulating device 1A of the second embodiment in that a vehicle air conditioning apparatus 2B has no temperature/humidity sensor 10. Further, when the conditions for implementing the battery warming-up operation are established, the temperature regulating device 1B heats the outside air that has flowed out of an outside air introduction passage 61, and allows only the heated outside air into the communication passage. Therefore, in performing the warm-up of the electric device, the temperature regulating device 1B does not blow the heated inside air, but always blows the heated outside air.

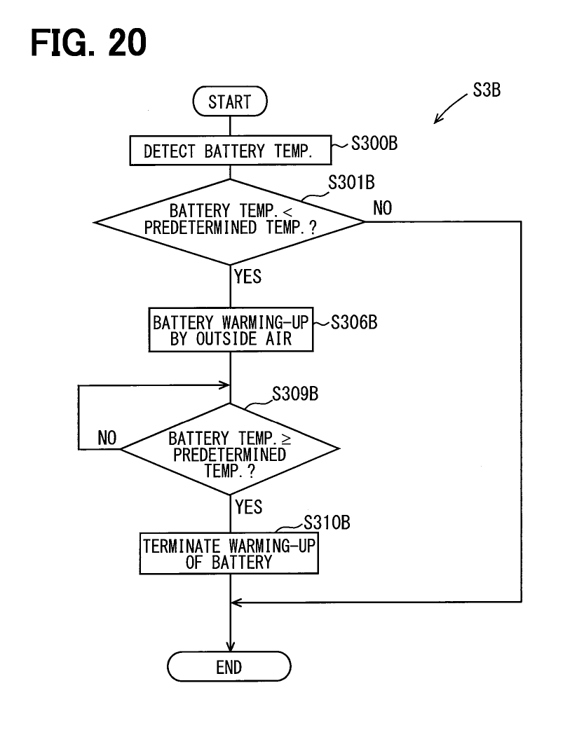

Subsequently, a description will be given of a processing procedure of a temperature regulation control involved in the vehicle interior heating operation and the battery warming-up operation in the temperature regulation control to be implemented by the temperature regulating device 1B with reference to flowcharts of FIGS. 19 and 20. A sub-routine illustrated in FIG. 20 is applied to, for example, a case in which preliminary battery warm-up for heating the battery in advance before charging is performed in charging at night.

Flowcharts in FIGS. 19 and 20 are mainly executed by the control device 100. Start conditions for the temperature regulation control involved in the vehicle interior heating operation and the battery warming-up operation are identical with those in the temperature regulation control described in the first embodiment with reference to FIGS. 3 and 4.

As illustrated in FIG. 19, it is determined whether there is a request for the heating operation for heating the vehicle interior, or not, in Step S1B. In Step S1B, the same determination as that in Step S1 of the first embodiment is performed.

If it is determined that there is the request for the heating operation in Step S1B, the flow proceeds to Step S4B. If it is determined that there is no request for the heating operation in Step S1B, it is determined whether there is the request for warming up the battery, or not, in Step S2B. In Step S2B, the same determination as that in Step S2 of the first embodiment is performed.

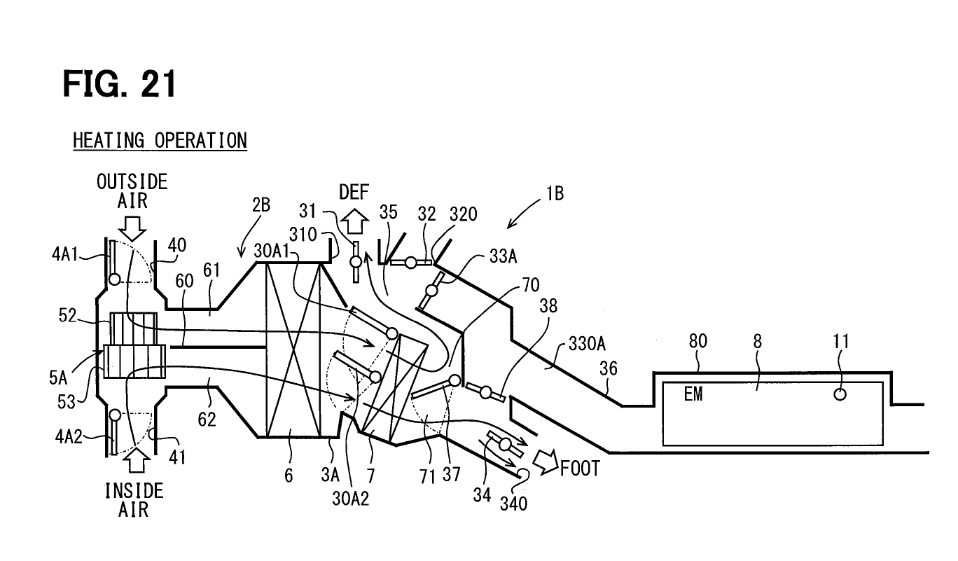

If it is determined that there is no request for warming up the battery in Step S2B, the flow returns to Step S1B. If it is determined that there is the request for warming up the battery in Step S2B, the flow returns to Step S1B after the warm-up control of the battery in Step S3B has been executed, and the process in this flow chart is repetitively executed. The warm-up control of the battery is executed according to the sub-routine illustrated in FIG. 20. When there is the heating request, the heating operation starts in Step S4B. In the heating operation, the operation illustrated in FIG. 21 is implemented as an example.

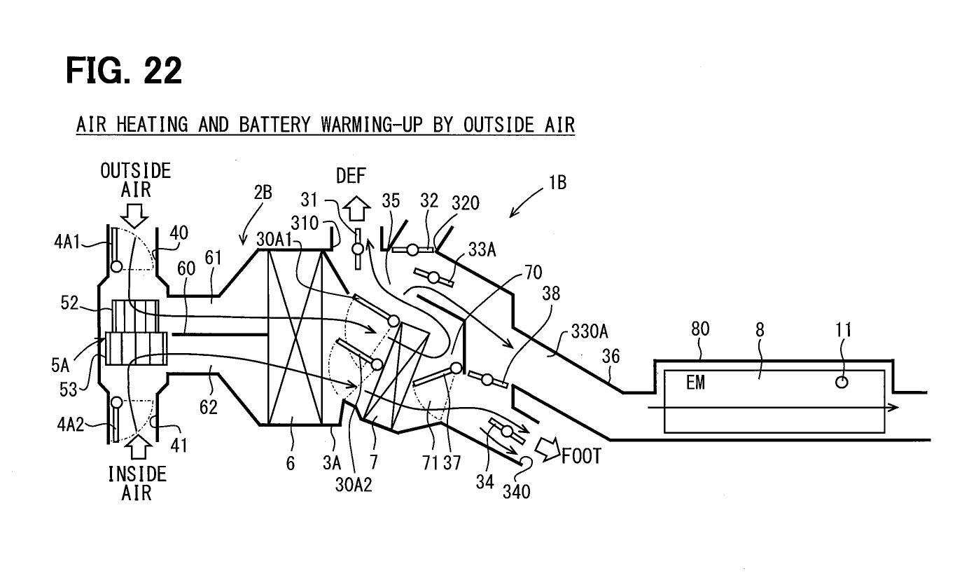

In Steps S5B and S6B, the same processes as those in Steps S5 and S6 of the first embodiment are performed, respectively. If the determination is no in Step S6B, this flowchart is terminated. If it is determined that the conditions for implementing the warming-up operation are established in Step S6B (yes), because the outside air low in the humidity is used for battery heating, the heating in the vehicle interior and the battery warming-up operation for supplying the outside air are implemented in Step S11B. In this operation, the respective components are controlled, for example, as illustrated in FIG. 22. In other words, in the operation of Step S11B, the same operation as that in Step S14A of the second embodiment described above is performed, and the same operation as that in the second embodiment is also applied to the operation of the respective components.

With the above configuration, after the outside air drawn into the vehicle air conditioning apparatus 2B has passed through an evaporator 6 through the outside air introduction passage 61, the outside air is heated by a condenser 7, and divided into a defroster passage 310 and a battery guide passage 330A through an upper side passage 70. The heated outside air is divided and supplied to the vehicle interior as a heating air, and also blown to the assembled battery 8 to heat and warm up the battery. After the inside air drawn into the vehicle air conditioning apparatus 2B has passed through the evaporator 6 through an inside air introduction passage 62, the inside air is heated by the condenser 7, flows into a foot passage 340 through a lower side passage 71, and is supplied into the vehicle interior.

Subsequently, it is determined whether the battery temperature is equal to or higher than a predetermined temperature, or not, in Step S19B. The predetermined temperature in this case is the same as the predetermined temperature in Step S6 of the first embodiment. The determination in Step S19B is repeated until it is determined that the battery temperature is equal to or higher than the predetermined temperature. If it is determined that the battery temperature is equal to or higher than the predetermined temperature in Step S19B, it is determined that the warm-up of the battery is completed by the implementation of the operation in Step S11B, and the warming-up operation of the battery is terminated in Step S20B. Therefore, in Step S20B, a control device 100B controls a temperature regulating door 33A to be at a position to close the battery guide passage 330A, and supplies the outside air heated by the condenser 7 to only the vehicle interior. Then, the control device 100B returns to Step S1B, and repetitively executes the processing in this flowchart.

Subsequently, a description will be given of the battery warm-up control when there is no heating request in Step S3B described above with reference to the subroutine illustrated in FIG. 20.

As illustrated in FIG. 20, in Steps S300B and S301B, the same processes as those in Steps S300 and S301 of the first embodiment are performed, respectively. If the determination is no in Step S301B, the subroutine is terminated, and the flow returns to Step S1B in FIG. 19.

If it is determined that the conditions for implementing the warming-up operation are established in Step S301B (yes), the battery warming-up operation for blowing the heated outside air to the assembled battery 8 as illustrated in FIG. 17 is implemented in subsequent Step S306B. In other words, in the operation of Step S306B, the same operation as that in Step S306A of the second embodiment described above is performed, and the same is also applied to the operation of the respective components.

With the above configuration, after the outside air drawn into the vehicle air conditioning apparatus 2B has passed through the evaporator 6 through the outside air introduction passage 61, the outside air is heated by the condenser 7, and flows into the battery guide passage 330A through the upper side passage 70. The heated outside air is blown to the assembled battery 8, and heats and warms up the battery.

Then, in Step S309B, the same determination as that in Step S309 of the first embodiment is performed. Step S309B is repeated until it is determined that the battery temperature is equal to or higher than the predetermined temperature. If it is determined that the battery temperature is equal to or higher than the predetermined temperature in Step S309B, it is determined that the warm-up of the battery is completed by the implementation of the operation in Step S306B, the warming-up operation of the battery is terminated in Step S310B, the subroutine is terminated, and the flow returns to Step S1B in FIG. 19.

According to the third embodiment described above, the temperature regulating device 1B includes the vehicle air conditioning apparatus 2B of the inside-outside-air two-layered type having the outside air introduction passage 61 in which the air drawn from the vehicle exterior flows, and the inside air introduction passage 62 in which the air drawn from the vehicle interior flows, as passages independent from each other. If it is determined that the warming-up operation of the electric device is necessary on the basis of the temperature of the electric device (assembled battery 8), the temperature regulating device 1B heats the vehicle exterior air flowing out of the outside air introduction passage 61, and blows the heated air to the electric device through the communication passage (battery guide passage 330A).

According to the above configuration, in the warming-up operation of the electric device, the outside air that can be assumed to be lower in humidity than the inside air is blown to the electric device. As a result, the generation of the dew condensation in the electric device can be suppressed. The generation of the dew condensation in the electric device is caused by blowing the inside air higher in humidity than the outside air due to the breath and sweating of the occupant. This makes it possible to suppress the dew condensation of the electric device and ensure the heating efficiency in implementing the warming-up operation on the electric device with the use of the conditioned air caused by the vehicle air conditioning apparatus 2B.

The temperature regulating device 1B includes the temperature-regulation object switching device (temperature regulating door 33A) that permits and blocks the flow of the air from the vehicle air conditioning apparatus 2B into the communication passage. When there is the request for heating operation in the vehicle interior, when it is determined that the warming-up operation for heating the electric device is necessary, the temperature regulating device 1B implements the warming-up operation of the electric device (S6B, S11B). In the warming-up operation of the electric device, the temperature regulating device 1B controls the temperature-regulation object switching device to permit the flow of the air, heats the outside air flowing out of the outside air introduction passage 61 to blow the heated air to the electric device through the communication passage, and also heats the inside air flowing out of the inside air introduction passage 62 to blow the heated air to the vehicle interior. If it is determined that the warming-up operation for heating the electric device is unnecessary when there is a request for heating operation in the vehicle interior, the temperature regulating device 1B controls the temperature-regulation object switching device to block the flow of the air, heats the inside air flowing out of the inside air introduction passage 62, and blows the heated air into the vehicle interior (S4B, 520B).

According to the above configuration, because the heated inside air is used for vehicle interior heating, the heating capacity can be suppressed as compared with a case of heating the outside air, and because the heated outside air is provided as the warm-up of the electric device, the dew condensation of the electric device can be suppressed by the air low in humidity. Therefore, both of the vehicle interior heating high in the heating efficiency and the dew condensation suppression can be performed.

The preferred embodiments of the present disclosure have been described in the above embodiments. However, the present disclosure is not limited to the above-mentioned embodiments, and can be variously deformed without departing from the spirit of the present disclosure.

The structures of the embodiments described above are merely examples and the scope of the present disclosure is not intended to be limited to the scope described above.

In the above second embodiment, when it is determined that the battery temperature is not equal to or higher than the predetermined value in Step S15A of FIG. 11, the determination in Step S17 of FIG. 3 according to the first embodiment may be performed instead of the embodiment in which the determination in Step S15A is again repeated. In other words, in FIG. 11, when the temperature of the vehicle interior air is equal to or lower than the predetermined humidity, a flowchart in which the mode switches from the outside air mode to the inside air mode in Step S18 of FIG. 3, and the flow proceeds to Step S19A may be employed.

According to the above configuration, when it is determined that the inside air has such a humidity that the dew condensation is not generated even in the warming-up operation of heating the outside air and blowing the heated air to the electric device, the flow of the outside air into the communication passage is blocked, and the heated inside air that has flowed out of the inside air introduction passage 62 is allowed to flow into the communication passage. When the inside air is higher in temperature than the outside air due to the switching of the warm-up air, because the inside air higher in heating efficiency than the outside air is used for the warming-up operation, the warming-up operation can be terminated earlier. As described above, the humidity level of the air blown to the electric device is monitored, and when there is no possibility of dew condensation, the inside air is positively heated and used for warm-up of the electric device. This makes it possible to provide the warming-up operation that improves the heating efficiency with the ensuring of the dew condensation prevention.

The electric device to be regulated in temperature according to the present disclosure can include an inverter, a motor, and an in-vehicle charger in addition to the assembled battery 8.

In the above embodiments, the temperature of the battery is detected by the battery temperature sensor 11. Alternatively, a temperature of the case housing the battery, a temperature of another member close to the battery, or an ambient temperature of the battery may be detected instead of a temperature of the battery to be regulated in temperature, as an index for determining a temperature state of the battery.

In the above embodiments, the temperature/humidity sensor 10 may be replaced with two sensors for detecting the respective temperature and humidity. The temperature/humidity sensor 10 and the humidity sensor 12 may be replaced with a dew point sensor for detecting a dew point. When the dew point sensor is used, the dew point and the temperature are found with the results that a relative humidity can be obtained.

The above embodiments perform characteristic control on the warming-up operation of the battery, and the characteristic control may be also applied to the cooling operation of the battery.

In the above embodiments, as heating means for heating the air blown to the assembled battery 8, the condenser 7 included in the heat pump cycle is employed. However, the present disclosure is not limited to the above configuration. The heating means may be configured by various electric heaters such as a heater core having an inverter coolant or an engine coolant as a heat source, a PTC heater that generates heat by energization, a sheath heater, or a halogen heater.

In the above embodiments, the doors 30 to 34, and 33A are each configured by an air route switching device having a plate-like door body part, but the present disclosure is not limited to this configuration. For example, each of those doors may employ a slide door, or a door having a film-like door body.

In the above embodiments, the shape of the electric cells configuring the assembled battery 8 formed in a flat rectangular parallelepiped shape or a cylindrical shape, and is not particularly limited.

What is claimed is:

1. A temperature regulating device, comprising:
a vehicle air conditioning apparatus that is mounted in a vehicle and blows a conditioned air to a vehicle interior;
a communication passage through which the vehicle air conditioning apparatus communicates with an electric device mounted in the vehicle, a conditioned air being conveyed from the vehicle air conditioning apparatus to the electric device through the communication passage;
a temperature detection device that detects a temperature of the electric device;
a humidity detection device that detects a humidity of an air in the vehicle interior or an air drawn into the vehicle air conditioning apparatus from the vehicle interior; and
a control device that controls an operation of the vehicle air conditioning apparatus according to temperature information detected by the temperature detection device and humidity information detected by the humidity detection device, wherein
the control device determines whether a warming-up operation for heating the electric device is necessary on the basis of the temperature of the electric device which is detected by the temperature detection device,
when the control device determines that the warming-up operation is necessary, and when the humidity of the air detected by the humidity detection device is equal to or lower than a predetermined humidity, the vehicle air conditioning apparatus blows the air, which is drawn from the vehicle interior and heated, to the electric device through the communication passage, and
when the control device determines that the warming-up operation is necessary, and when the humidity of the air detected by the humidity detection device exceeds the predetermined humidity, the vehicle air conditioning apparatus blows air, which is drawn from a vehicle exterior and heated, to the electric device through the communication passage.

2. The temperature regulating device according to claim 1, wherein
the vehicle air conditioning apparatus is a vehicle air conditioning apparatus of an inside-outside-air two-layered type including an outside air introduction passage in which the air drawn from the vehicle exterior flows, and an inside air introduction passage in which the air drawn from the vehicle interior flows, the introduction passages being independent from each other, and
the control device performs
a first warming-up operation in which air flowing from the vehicle exterior through the outside air introduction passage is heated and blown into the vehicle interior, and air flowing from the vehicle interior through the inside air introduction passage is heated and blown to at least the electric device, or
a second warming-up operation in which air flowing from the vehicle interior through the inside air introduction passage is heated and blown into the vehicle interior, and air flowing from the vehicle exterior through the outside air introduction passage is heated and blown to at least the electric device.

3. The temperature regulating device according to claim 1, wherein
when the humidity of the air detected by the humidity detection device exceeds the predetermined humidity in a state where the air drawn from the vehicle interior and heated is blown to the electric device through the communication passage, the control device controls the operation of the vehicle air conditioning apparatus to be switched into a state where the air drawn from the vehicle exterior and heated is blown to the electric device through the communication passage.

4. The temperature regulating device according to claim 1, wherein
when the humidity of the air detected by the humidity detection device is equal to or lower than the predetermined humidity in a state where the air drawn from the vehicle exterior and heated is blown to the electric device through the communication passage, the control device controls the operation of the vehicle air conditioning apparatus to be switched into a state where the air drawn from the vehicle interior and heated is blown to the electric device through the communication passage.

5. A temperature regulating device, comprising:
a vehicle air conditioning apparatus that is mounted in a vehicle and blows a conditioned air to a vehicle interior, the vehicle air conditioning apparatus being a vehicle air conditioning apparatus of an inside-outside-air two-layered type and including an outside air introduction passage in which the air drawn from the vehicle exterior flows, and an inside air introduction passage in which the air drawn from the vehicle interior flows, the introduction passages being independent from each other;
a communication passage through which the vehicle air conditioning apparatus communicates with an electric device mounted in the vehicle, a conditioned air being conveyed from the vehicle air conditioning apparatus to the electric device through the communication passage;
a temperature detection device that detects a temperature of the electric device; and
a control device that controls an operation of the vehicle air conditioning apparatus according to temperature information detected by the temperature detection device, wherein
when the control device determines that a warming-up operation for heating the electric device is necessary on the basis of the temperature of the electric device which is detected by the temperature detection device, the control device performs heating of air flowing from the vehicle exterior through the outside air introduction passage and performs blowing of the heated air to the electric device through the communication passage.

6. The temperature regulating device according to claim 5, further comprising a temperature-regulation object switching device that permits or blocks a flow of the air from the vehicle air conditioning apparatus to the communication passage, wherein
in a case where the control device is requested to perform an operation to heat the vehicle interior,
when the control device determines that the warming-up operation for heating the electric device is necessary on the basis of the temperature of the electric device which is detected by the temperature detection device, the control device controls the temperature-regulation object switching device to permit the flow of the air, the control device performs heating of air flowing from the vehicle exterior through the outside air introduction passage and performs blowing of the heated air to the electric device through the communication passage, and the control device performs heating of air flowing from the vehicle interior through the inside air introduction passage to blow the heated air to the vehicle interior, and
when the control device determines that the warming-up operation for heating the electric device is not necessary on the basis of the temperature of the electric device, the control device controls the temperature-regulation object switching device to block the flow of the air, and the control device performs heating of air flowing from the vehicle interior through the inside air introduction passage and performs blowing of the heated air to the vehicle interior.

7. The temperature regulating device according to claim 1, wherein the electric device is a secondary battery that stores an electric power for vehicle travel.
